(19) United States
(12) Patent Application Publication
(10) Pub. No.: US 2007/0283088 A1
(43) Pub. Date: Dec. 6, 2007

(54) Method and apparatus for transformation of storage virtualization schemes

(76) Inventor: Barry Hannigan, Williamstown, NJ (US)

Correspondence Address: BECK AND TYSVER P.L.L.C., 2900 THOMAS AVENUE SOUTH, SUITE 100, MINNEAPOLIS, MN, 55416, US

(21) Appl. No.: 11/443,520

(22) Filed: May 30, 2006

(51) Int. Cl. G06F 12/16

(52) U.S. Cl. 711/114

(57) ABSTRACT

The present invention is a method and apparatus for simplifying the representation of storage virtualization schemes using a set of rules and standardizing such representations in a form having ready practical applicability. The invention provides rules to be implemented in hardware or software logic for transforming between representations from various sources, such as from an object-oriented form into a form suitable for hardware from a particular vendor.

### CROSS-REFERENCE TO ANOTHER APPLICATION

This application is related to the application filed on May 30, 2006, entitled “Method and Structure for Adapting a Storage Virtualization Scheme Using Transformations” having inventor Barry Hannigan and Beck & Tysver attorney docket number 3529.

### FIELD OF THE INVENTION

The present invention relates generally to storage virtualization in networked computer systems. More particularly, it relates to a method and apparatus for transforming storage virtualization schemes involving RAID functions into alternative forms, including a flexible normal form.

### BACKGROUND OF THE INVENTION

Storage virtualization (SV) inserts an abstraction layer between a host system (e.g., a system such as a server or personal computer that can run application software) and physical data storage devices. The text by Tom Clark (Storage Virtualization, Addison Wesley, 234 pp., 2005) provides an excellent introduction. Storage that appears to the host as a single physical disk unit (pDisk) might actually be implemented by the concatenation of two pDisks. The host is unaware of the concatenation because the host addresses its disk storage through an interface. A simple write operation by the host of a range of storage blocks starting at a single block address can result in a storage controller performing a series of complicated operations, including concatenation of disks, mirroring, and data striping. In effect, the host is interacting through the interface with a virtual disk unit (vDisk). Of course, a vDisk “drive” can be implemented with a pDisk drive. In summary, an SV scheme is a mapping behind the interface from a unit of source vDisk to one or more units of target vDisk (or pDisk), the mapping done by successive operations like concatenation, mirroring, and striping.

Virtualization of host operations at the data block level is called block virtualization. Virtualization at the higher level of files or records is also possible.

Present technologies for providing physical disk storage to a host include: (1) storage that is within or directly attached to the host; (2) network-attached storage (NAS), which is disk storage having its own network address that is attached to a local area network; and (3) storage attached to a storage area network (SAN) acting as intermediary between a plurality of hosts and a plurality of block subsystems for physical storage of the data. Virtualization can be performed in different storage subsystems: within the host, within the physical storage subsystem, and within the network subsystem between the host and the physical storage (e.g., within a SAN).

Through storage virtualization, a number of changes can be made to improve system reliability, performance, and scalability, all transparently to the host. Data mirroring, data striping, and concatenation of disk drives are three fundamental functions to achieve these improvements. Redundant Array of Inexpensive Disks (RAID) is a set of techniques that are central to storage virtualization. RAID level 0 includes data striping; level 1 includes mirroring. RAID 0+1 (sometimes alternatively denoted as “RAID 01”) includes both mirroring and striping. Higher levels of RAID also include these basic functions.

Mirroring is the maintenance of copies of the same information in multiple physical locations. Mirroring improves reliability by providing redundancy in the event of drive errors or failure. It can also speed up read operations, because multiple drive heads can read separate portions of a file in parallel.

Data striping is a method for improving performance when data are written. The extent of a source vDisk is divided into chunks (strips) that are written consecutively to multiple target disks in rotation. The number of target disks is the fan number or fan of the striping operation. Typically, the number of strips is an integer multiple of the fan number. The strip size is the amount of data in a strip. A stripe consists of one strip written per each of the target disks. The stripe size is equal to the strip size multiplied by the fan number. The total extent (i.e., number of blocks or bytes) of target disk required is equal to the extent of the source vDisk because, although striping reorganizes the data, the amount of data written remains the same.

Concatenation is the combining of one or more target disk units (either vDisk or pDisk) to support expansion of a single unit of source vDisk. Concatenation can thereby facilitate scaling of host file and record data structures using what, for all intents and purposes, is a larger disk drive for host use. Thus, for example, a database on a server can grow beyond the size limits of a single physical drive volume transparently to users and applications. The concatenation function is not a separate RAID 0+1 function as such, but can be regarded as a special case of the stripe function where the strip size is equal to the extent of any one of the target disks and hence only a single stripe is written. Because of its fundamental role in SV, we choose to treat concatenation as a separate atomic function.

The concept of a fan number or fan applies to the other atomic SV functions as well as to striping. A mirroring function with a fan number of 3, for example, represents what appears to the host to be one unit of disk as 3 separate copies. For concatenation, the fan is the number of disk units that are being combined together to appear as a single unit of vDisk. For striping, the fan is the number of strips within a stripe, or equivalently the number of disk units over which the data are being spread.

Mirroring, striping, and concatenation (CAT) are atomic functions that can be combined together in a sequence within an SV scheme to form composite functions, also known as compositions. These three atomic functions will be referred to collectively as the SV core functions. In the early days of RAID operations, developers of logic (e.g., a network processor Application Specific Integrated Circuit (ASIC)) mapping vDisk to pDisk were well prepared to implement a small set of core function constructs. Two familiar composite functions that have been handled straightforwardly for several years within network controllers are (1) a concatenation followed by a mirror, followed by a stripe function, and (2) a concatenation followed by a stripe, followed by a mirror function.

With larger and more complex systems, a need has been perceived to handle much more general and complicated sequences of atomic functions. In particular, the proposed Fabric Application Interface Standard (FAIS), which embodies current thinking about what is required in this context, defines a model to represent a RAID SV scheme in object-oriented (OO) form (American National Standard for Information Technology, Fabric Application Interface Standard (FAIS), rev. 0.7, Sep. 13, 2005, FIG. 5.3, which is incorporated herein by this reference). Elements of such a model must be recursively traversed to determine the full sequence of functions to be implemented in a given scheme.

The sequence of atomic RAID functions in a given SV scheme can be quite long; in fact, it can have, in principle, any finite length. Implementing such a scheme representation literally, particularly within hardware, could be quite difficult and expensive—certainly more so than has been required of developers of such logic in the past. Moreover, when the SV scheme is not static, but changes dynamically over time, the complexity of providing a general solution appears prohibitive. Confounding the problem further are the possibilities of implementations involving more than one storage subsystem, and heterogeneous deployments within a subsystem.

### SUMMARY OF THE INVENTION

The present invention addresses these problems with a novel mapping method. Instead of implementing a complex SV scheme literally “as is” with hardware or software logic, the invention is based on the concept of transforming the sequence of atomic functions composing an SV scheme into an equivalent, usually simpler, form. When feasible, it is often convenient to transform into a normal form, either as a final SV scheme or as a standardized intermediate. We will refer to a normal form for an SV scheme as an SV-normal form.

This concept applies readily to the SV core functions (i.e., RAID 0+1 plus concatenation), as well as to other RAID levels that do not introduce any new functions but which incorporate parity data to improve data recoverability such as RAID 5. The inventive concept applies more generally to any set of atomic functions to be applied in sequence having behavior similar to the core functions as is specified in the Detailed Description section.

A source vDisk is mapped by an atomic function into a number of target vDisks (which could be implemented as pDisks). As already mentioned, the number of target units (nodes) produced for a given source node is the fan number of the atomic function. The overall SV scheme, mapping from source nodes to target nodes through various operations can be represented in a tree structure (analogous to a tree structure in a hierarchical file system, where the nodes are files or directories). A tree depicting an SV scheme will be referred to as an SV tree. An SV tree and other equivalent representations of an SV scheme, such as a composite function or an OO model, will be said to describe an SV tree.

An SV tree will be highly symmetrical if at each level, the same atomic function with the same fan number is used to map all nodes at that level into the nodes at the next level. In such an SV tree, the atomic function type can vary from level to level, but not within a level. We will refer to a whole SV tree, or a subtree embedded in a larger tree having these properties, as an SV-balanced tree. Any function that describes an SV-balanced tree can be normalized. Certain subtrees of a tree that is not itself SV-balanced might be SV-balanced.

An SV-balanced tree can alternatively be represented in a mathematical form as a composition of atomic SV functions. For example, the composition (CAT|mirror|stripe|mirror) represents a concatenation, followed by a mirror, a stripe, and finally another mirror function. A pipe, or vertical bar, symbol ‘|’ has been used to separate the atomic functions in the sequence. The pipe symbol can be read “over”, so this sequence can be read “CAT over mirror over stripe over mirror.” Note that an SV scheme represented as a composition of atomic functions is necessarily SV-balanced.

Two compositions of atomic SV functions that are distinct in the details of how they map data might nevertheless be equivalent. Consider the composition of a 2-way mirror followed by a 3-way mirror to pDisk. This is equivalent to a composition consisting of just a 6-way mirror to pDisk. In this particular example, the two equivalent compositions would produce identical arrangements of data on pDisk. However, it is not a necessary condition for equivalence that the resulting data arrangements be identical, just that the arrangements be functionally the same. Examples and discussion of the equivalence concept are deferred until the Detailed Description section. Suffice it to say at this point that one aspect of the invention is a set of rules for transforming a composite into equivalent ones.

Key to the invention are two basic facts about adjacent levels of atomic storage functions within a composite sequence: (1) if the levels are of like type (e.g., adjacent levels of mirror type), they can be collapsed into a single level of that type; (2) if they are of different types their order can be swapped (e.g., (CAT|stripe) becomes (stripe|CAT)). Actually, swapping can also be used on adjacent levels of like type, but that is more unusual. Also, a single level of a given type can be split into two levels of that type. In addition to manipulations of sequences of atomic functions, the invention also provides methods to determine various details such as fan numbers, node quantities, data extents at each level, and how the data are distributed among target disks. Discussion of such details is deferred to the Detailed Description section.

Normalization is a transformation of a given composite function into an equivalent one having SV-normal form. Whether a particular composite is in SV-normal form depends only upon the sequence of atomic function types from which it is composed. So, for example, SV-normal form does not depend upon how many copies of the data a given mirror function makes, or the extent of a source vDisk. Any composition that includes at least one of each of the atomic function types is acceptable as an SV-normal form. Of these infinitely many choices, only 3 are of obvious interest—namely, those 6 distinct composition sequences formed from the various orderings of the 3 atomic function types without repetition.

In the preferred embodiment, the SV-normal form is (CAT|mirror|stripe). This specific sequence of function types is one that, as mentioned in the Background section, some developers of storage controllers have already routinely implemented.

The inventor has discovered that any composite function (or, equivalently, any SV-balanced tree) based on the 3 core types, no matter how simple or how complex, can be reduced to (any choice of) SV-normal form. This will be proven in the Detailed Description section using the invention's rules for level manipulations. An algorithm based on level manipulation to perform the normalization or flattening can be implemented in logic (i.e., logic adapted to execute on a digital electronic device in hardware or software.

A comment is in order at this point about the use of the conjunction “or”. Throughout this application including the claims, the word “or” means “inclusive or” unless otherwise specified in the context. Thus, the phrase “hardware or software” in the preceding paragraph includes hardware only, software only, or both hardware and software.

The ability to convert an arbitrarily long sequence of atomic functions into such a simple SV-normal form is quite powerful. Instead of having to implementing any and all desired composition sequences individually, it becomes sufficient for an implementer of an SV scheme to merely implement SV-normal form. If an SV scheme can be represented as an SV-balanced tree, then logic can preprocess the tree into SV-normal form. In essence, SV-normal form is a de facto standard for SV that serves as a simpler practical alternative to an object-orientated model such as FAIS.

Standardization upon a single SV-normal form can dramatically simplify automation, a critical goal of SV. Flattening can be done in preprocessor logic in a fraction of a second. The SV deployment would not need to deal with all possible sequences and orderings of atomic functions, merely how to transition from one SV-normal form instance to another. Such transitioning can typically be accomplished by simply repopulating some tables.

Legacy SV implementations are another application of the invention. Consider a device that is configured to implement only a limited class of sequences of atomic function types that are not in the SV-normal form of our preferred embodiment. An adapter or shim enabled with the transform logic of the invention can translate any composite function into the legacy form, perhaps using an SV-normal form as an intermediate form. Translation from SV-normal form to some other form can take advantage of the fact that the level manipulations of the invention have inverses.

Another embodiment of the invention relates to the combined effect of SV functions (whether composite or atomic) deployed to different SV subsystems. For example, concatenation might be carried out on the host, followed by mirroring in a Fibre Channel fabric, and then striping in the physical storage subsystem. There are many reasons why such distributed functionality might be advantageous in particular situations. For example, mirroring in the network subsystem could, for security reasons, maintain redundant copies of critical data to be stored at geographically remote facilities. A universal storage application can manage the combined SV scheme, deploying subtrees to the respective subsystems when a change to the combined scheme is requested. The universal storage application knows how to perform SV scheme transformations with the transform logic of the invention, perhaps using an SV-normal form in the process. Each subsystem receiving a deployed subtree might also use SV-normal form directly or as an intermediary in converting to a local normal form that takes best advantage of the capabilities and limitations of the particular device.

### BRIEF DESCRIPTION OF THE DRAWINGS

FIG. 1 is a tree diagram for the concatenate (CAT) function illustrating definitions and notation.

FIG. 2 shows two equal SV trees illustrating the notational convenience of omitting internal vDisk nodes.

FIG. 3 shows tree diagrams for the CAT, stripe, and mirror atomic SV functions.

FIG. 4 shows a sequence of steps in which the extents and quantities are equilibrated stepwise in a sample SV composite function expressed as an equation.

FIG. 5 includes four tree diagrams illustrating that CAT, stripe, and mirror functions having fan numbers equal to 1 are identity functions.

FIG. 6 uses tree diagrams to show the effect of combining two adjacent CAT node levels.

FIG. 7 uses tree diagrams to show the effect of combining two adjacent stripe node levels.

FIG. 8 uses tree diagrams to show the effect of combining two adjacent mirror node levels.

FIG. 9 uses tree diagrams to show the effect of swapping adjacent CAT and mirror node levels.

FIG. 10 uses tree diagrams to show the effect of swapping adjacent stripe and mirror node levels.

FIG. 11 uses tree diagrams to show the effect of swapping adjacent CAT and stripe node levels.

FIG. 12 shows a sequence of algebraic steps by which a sample SV composite function is converted to SV-normal form.

FIG. 13 shows trees diagrams corresponding to the initial and SV-normal form composite functions of the previous figure.

FIG. 14 is a flowchart showing a shortcut method for transforming into SV-normal form.

FIG. 15 shows tree diagrams for a first example of tracing of disk contents from a given composition to its normalized equivalent in the basic case.

FIG. 16 shows tree diagrams for a second example of tracing of disk contents from a given composition to its normalized equivalent in the basic case.

FIG. 17 shows tree diagrams illustrating the distribution of disk contents when combining adjacent stripe levels in a case in which the stripe function levels are strongly matched and a case in which the stripe function levels are weakly matched.

FIG. 18 shows tree diagrams illustrating the distribution of disk contents when combining adjacent stripe levels in a case in which the stripe functions are strongly matched and a case in which the stripe functions are unmatched.

FIG. 19 is a diagram illustrating the role of the invention acting as an adapter between two representations of SV composite functions, one being the object-oriented model of the proposed FAIS standard, and the other being a vendor-specific network processor ASIC.

FIG. 20 is a diagram showing conversion of a given SV composite function into SV-normal form and implemented within a network processor mapping table having columns corresponding to the levels in the SV-normal form representation.

FIG. 21 shows the conversion of an unbalanced SV tree into a balanced one.

FIG. 22 is a diagram illustrating an existing SV deployment before an upgrade.

FIG. 23 is a diagram, corresponding to the previous figure, introducing a new intelligent Fibre Channel fabric and a new universal storage application.

FIG. 24 is a diagram, corresponding to the previous figure, showing the SV scheme being converted to an SV-normal form within the universal storage application.

FIG. 25 is a diagram, corresponding to the previous figure, showing the universal storage application partitioning the SV normal form scheme into subtrees for deployment to separate subsystems.

FIG. 26 is a diagram, corresponding to the previous figure, showing deployment of the SV subtrees to respective subsystems.

FIG. 27 is a diagram, corresponding to the previous figure, illustrating a subsystem transforming a subtree that it has received from the universal storage into a convenient local normal form.

FIG. 28 is a diagram, corresponding to the previous figure, showing modifications to the SV scheme within the universal storage application consequent to the introduction of a new remote RAID array from a second vendor.

FIG. 29 is a diagram, corresponding to the previous figure, showing two disks being freed up by the remote mirroring deployment.

### DETAILED DESCRIPTION OF THE INVENTION

### Introduction

In order for an electronic device such as a host computer to access a physical disk for input or output (I/O) of data, the device must specify to an interface a location on the target drive and the extent of data to be written or read. The start of a unit of physical storage is defined by the combination of a target device, a logical unit number (LUN), and a logical block address (LBA). A physical storage device also has an extent or capacity. Disk I/O is typically done at the granularity of a block, and hence the name block virtualization. On many drives, a block is 512 bytes. The concept of storage virtualization (SV) is to replace the physical disk (pDisk) behind the interface with a virtual disk (vDisk) having functionality that achieves various goals such as redundancy and improved performance, while still satisfying the I/O requests of the accessing device. The focus of the invention is SV at the block level, but SV at higher levels such as the file/record level is not excluded from its scope.

As an example of virtualization, a host might write data to disk through a SCSI interface. Behind the interface, mirroring can be done for redundancy and security. Concatenation (CAT) of drives facilitates scalability of host storage by allowing the extent of vDisk available to the accessing host to grow beyond the size of a single physical device. Mirroring provides storage redundancy. Striping of data can improve read performance.

A variety of ways exist to implement pDisk storage for a host. A drive can be directly connected, implemented as network-attached storage (NAS), or available through a storage area network (SAN) (e.g., one implemented within a Fibre Channel fabric). Virtualization can take place anywhere in the data path: in the host, network, or physical storage subsystems. If done manually, maintenance of an evolving SV configuration is a time consuming, detailed and tedious task, so facilitating automation is an important goal of any process related to SV.

Within a network subsystem implemented as a SAN, for example, a correspondence is maintained between units of vDisk on servers and, ultimately, one or more corresponding units of pDisk. The SAN does so through some combination of network hardware and controlling software, which might include a RAID controller or a Fibre Channel fabric. The correspondence, or mapping, facilitates standard I/O functions requested by application programs on the servers. The SAN is one possible site for virtualization to transparently improve performance and guarantee data redundancy.

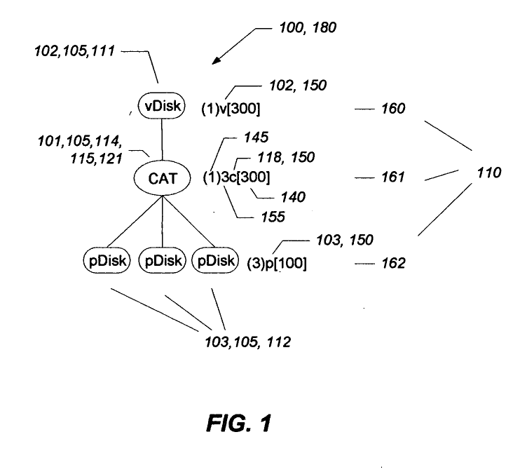

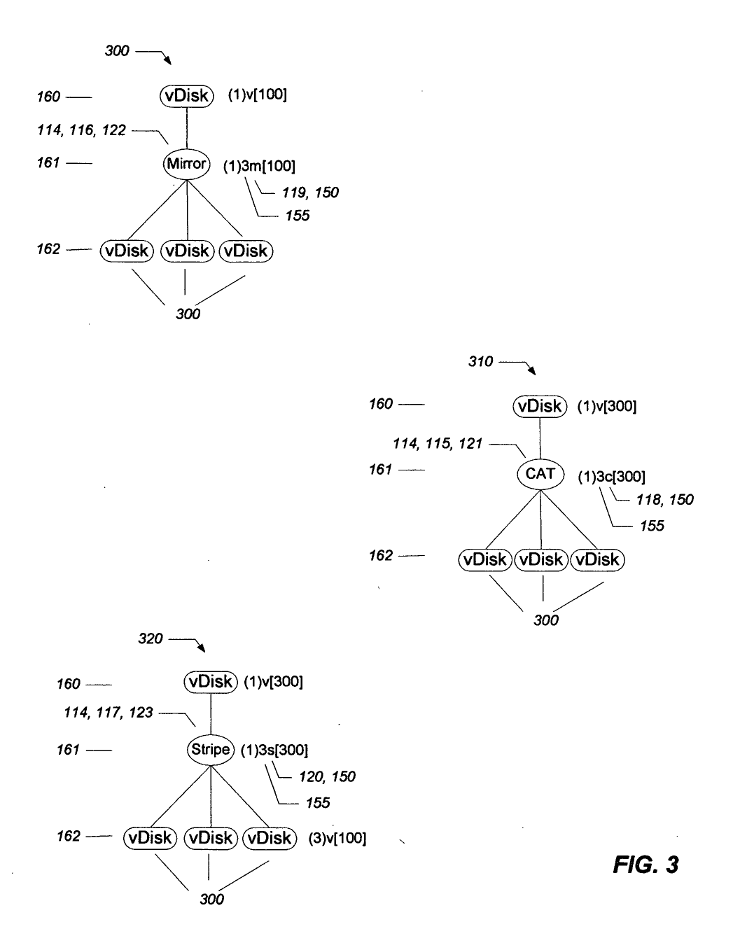

FIG. 1 is a diagram that illustrates terminology that will be used throughout the remainder of the Detailed Description and claims. Units of disk have a type 150, either vDisk 102 or pDisk 103. In SV, source vDisk 102 units are mapped to target pDisk 103 or vDisk 102 units by operation of SV atomic functions 101. Each SV atomic function 101 also has a type 150 such as mirror 119, stripe 120, or CAT 118 type (see also FIG. 3). Such a mapping can be depicted with a tree structure or tree diagram. A tree that represents an SV mapping will be referred to as an SV tree 100. FIG. 1 shows a particularly simple SV tree 100 depicting the mapping of a single vDisk node 111 by a CAT node 115 into 3 pDisk nodes 112. The vDisk node 111, CAT node 115, and pDisk nodes 112 stand for a vDisk 102 unit, a CAT function 121, and 3 pDisk 103 units, respectively. The SV tree 100 shown includes a total of 5 nodes 105 at 3 levels 110. At the top of the SV tree 100, level 0 160 always contains a single node 105, in this case a vDisk node 111. The single top node of a tree is called its root. Levels 110 are assigned consecutively larger numbers proceeding down the tree. The CAT node 115 is a function node 114 at level 1 161. The 3 pDisk nodes 112 occupy level 2 162.

The vDisk node 111 has one child node in the figure; namely, the CAT node 115, of which the vDisk node 111 is the parent. The CAT node 115, in turn, is the parent of three children pDisk nodes 112. A pDisk node 112 never has any children, so it is necessarily a leaf node of the tree. A vDisk node 111 can appear anywhere in the tree.

In addition to a type 150, an SV atomic function 101 also has a fan number 155 (or fan 155) parameter, which is its number of children. Because a function node 114 always has children, it can never be a leaf node. The fan 155 of a vDisk node 111 will be 0 or 1, depending on whether it has any children. The fan 155 of a pDisk node 112 is 0.

The type 150 and fan number 155 of a node 105 are parameters of the node 105. When convenient, the type 150 of a node 105 will be abbreviated as follows: ‘v’ for vDisk; ‘p’ for pDisk; ‘c’ for CAT; ‘m’ for mirror; and ‘s’ for stripe. The type 150 of the CAT node 115 in the figure is CAT 118. A vDisk node 111 or pDisk node 112 also has an extent 140. The extent 140 is the data capacity of the disk node 105. As shorthand that will be explained through the next figure, each function node 114 is also assigned an extent 140. A stripe function 123 has the two additional parameters, stripe size and strip size; these parameters will be discussed further as relevant.

When the node 105 parameters are shown in a tag to the right of each level 110 as in the figure, they apply to all nodes 105 at that level 110. The notation for level 1 161 is typical: “(1)3c[300]”. The level 110 contains one node (‘(1)’). The node 105 is a CAT node 115 (‘c’) with a fan number 155 of 3 (‘3’). The extent 140 of each node 105 in the given level 110 is 300 (‘300’). The fan number 155 will be omitted from display of vDisk 102 nodes and pDisk nodes 112.

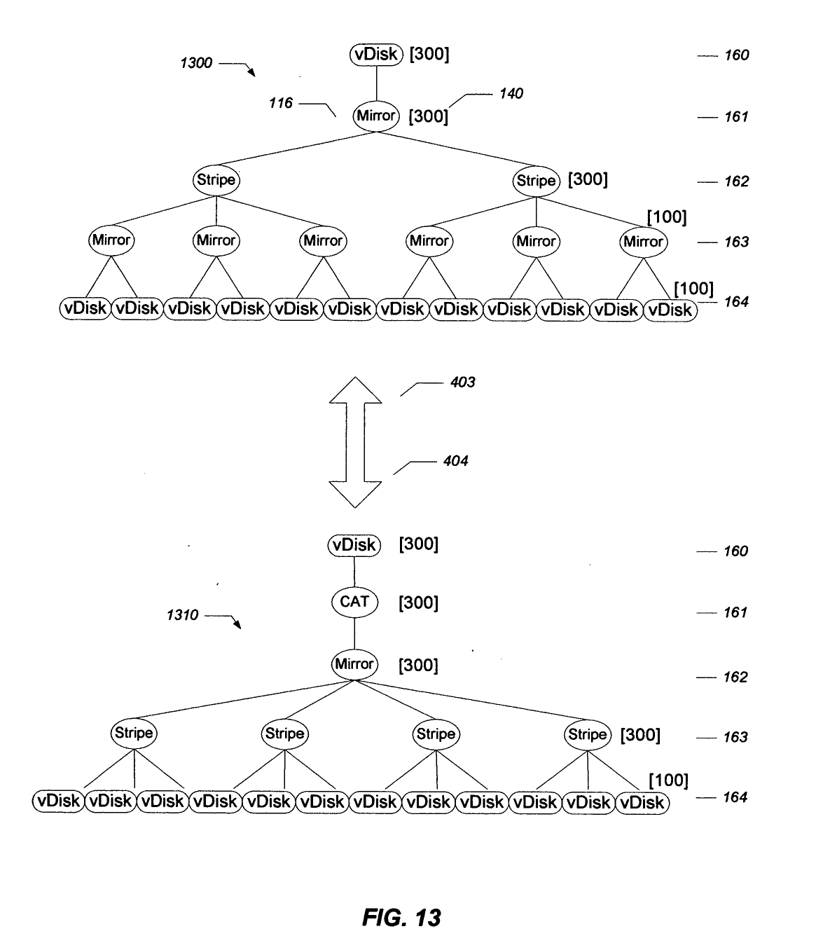

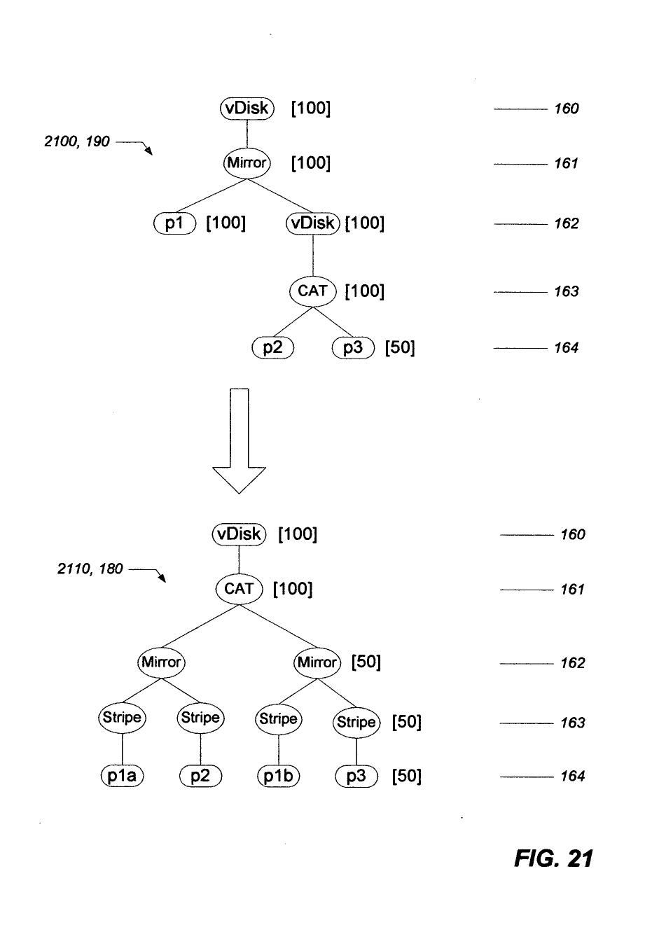

We define an SV mapping and its associated SV tree 100 to have the SV-balanced property if, at each level, the values of the various node parameters (i.e., type 150, fan number 155, extent 140, and for a stripe node 117, stripe size and strip size) are the same for all nodes within that respective level. An SV tree 100 will be termed an SV-balanced tree 180 if it possesses the SV-balanced property. For an SV-balanced tree 180, it makes sense to display a tag to the right of each level 110 listing the type 150, extent 140, and of fan number 155 of nodes 105 in that level 110. It is also informative for the tag to display the quantity 145 of nodes in each level 110. The SV tree 100 in FIG. 1 is an SV-balanced tree 180, as are the more complex trees depicted by, for example, FIG. 13. Any SV tree 100 that is not SV-balanced will be referred to as SV-unbalanced. The upper 2100 SV tree 100 shown in FIG. 21 is an example of an SV-unbalanced tree 190. The rules of the invention pertain to SV-balanced trees 180, to SV-balanced subtrees of SV-unbalanced trees 190, and to conversion of SV-unbalanced trees 190 into SV-balanced trees 180.

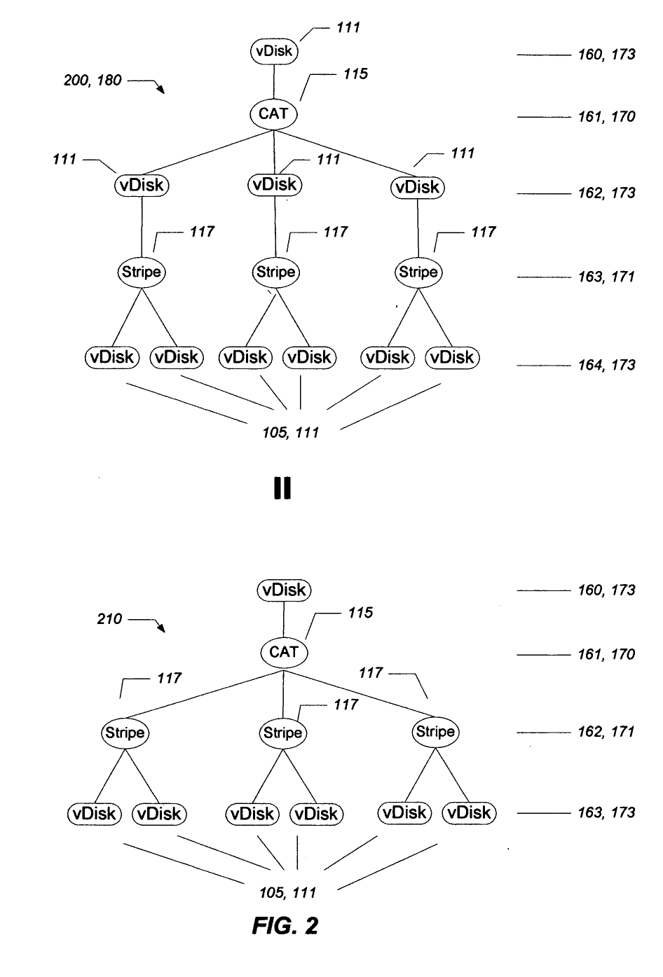

A shortcut in our SV tree 100 notation is illustrated by FIG. 2. A function node 114 (e.g., CAT node 115, mirror node 116, or stripe node 117) maps one source vDisk node 111 into one or more target disk nodes. Note that any leaf vDisk node 111 can always be implemented as a pDisk node 112, so it makes sense to regard the target nodes as vDisk nodes 111. The quantity 145 of target nodes 105 is determined by the fan 155 of the atomic function 101. The upper 200 SV tree 100 shows a vDisk node 111 at level 0 160 mapped by a CAT node 115 (having a fan of 3) at level 1 161 into 3 vDisk nodes 111 at level 2 162. In this SV-balanced tree 180, each of the level 2 162 vDisk nodes 111 is operated upon by an stripe node 117 (having a fan of two) at level 3 163, producing a total of 6 vDisk nodes 111 at level 4 164. The vDisk nodes 111 at level 3 are internal, sandwiched between a level 110 of CAT nodes 115 and a level 110 of stripe nodes 117. As illustrated by the lower tree 210 in FIG. 2, for notational convenience the internal vDisk nodes 111 will be customarily omitted, condensing an SV tree 100 into fewer levels 110—in this case, from 5 to 4.

Because a function node 114 actually represents both a vDisk node 111 and an atomic function 101 operating upon that vDisk node 111, it makes sense to associate an extent 140 with a function node 114 as was done in the previous figure. Note that it is always appropriate when convenient to explicitly insert a vDisk level 173 between a two function levels situated in adjacent levels of an SV tree 100. Such insertion is fundamental to the invention and will be used in subsequent discussion.

FIG. 3 provides SV tree 100 diagrams (300, 310, and 320) illustrating the three core SV atomic functions: the CAT function 121, stripe function 123, and mirror function 122, respectively. Each of the diagrams has a vDisk node 111 at level 0 160, a function node 114 having a fan 155 of 3 at level 1 161, and 3 target vDisk nodes 111 (each with an extent 140 of 100) at level 2 162. We will use nondimensional numbers for extents 140; these could represent blocks or some other unit of capacity. The most important thing to notice in this figure is that for the mirror node 116 (top tree 320), the extent 140 of the source vDisk node 111 (100) is equal to the extent 140 of each target vDisk node 111 (100). In contrast, for the CAT node 115 (center tree 300) and the stripe node 117 (bottom tree 310), the extent 140 (300) of the source vDisk node 111 is equal to the fan number 155 (3) of the function multiplied by the extent 140 of each target vDisk node 111 (100). This distinction is due to the fact that mirror makes redundant copies of the source data, while CAT and stripe merely redistribute the source data across multiple nodes. The source vDisk node 111 and any function node 114 in level 1 161 always have the same extent 140. The process of fleshing out an SV-balanced tree with the extent 140, node quantity 145, and fan number 155 for each level is called equilibration.

### Rules for Equilibrating Quantities and Extents

We now formally summarize the rules for equilibrating quantities and extents in an SV-balanced tree 180, which follow from FIG. 3 and the associated discussion above. Let level L and level L+1 be adjacent levels in the tree. Then the following rules obtain:
E1 (vDisk extent)—The extent 140 of a vDisk node 111 in level L is equal to the extent 140 of its child node 105, if any, in level L+1.
E2 (mirror extent)—The extent 140 of a mirror node 116 in level L is equal to the extent 140 of its child nodes 105 in level L+1.
E3 (CAT/stripe extent)—The extent 140 of a CAT node 115 or a stripe node 117 in level L is equal to the extent 140 of its child nodes 105 in level L+1 multiplied by the fan 155 of the CAT node 115 or stripe node 117, respectively.
E4 (quantity)—The quantity 145 of nodes 105 in level L+1 is equal to the quantity 145 in level L multiplied by the fan 155 of the nodes 105 in level L.

### Algebraic Representation of SV-Balanced Trees as Compositions

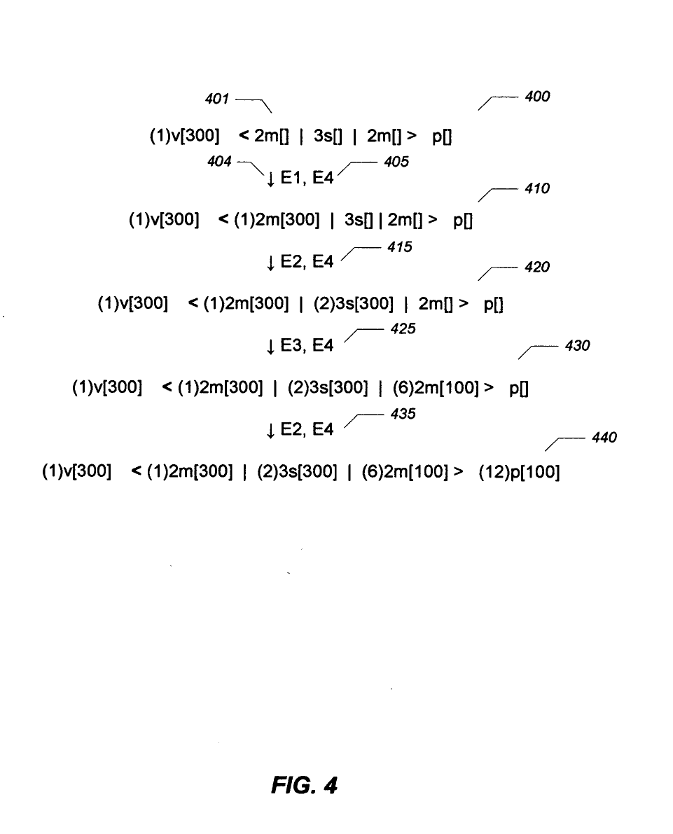

An SV-balanced tree 180 can be represented as a composite function 401, also known as a composition 401, formed by a set of SV atomic functions to be applied in sequence. In FIG. 4, a composite function 401, mapping from source vDisk 102 to target pDisk 103, is depicted in an algebraic form. The upper tree 1300 of FIG. 13 is the corresponding SV tree 100 representation. The composition is said to describe the tree, and conversely, because the forms are equivalent. The composite function 401 is shown enclosed between angle brackets ‘<’ and ‘>’. Pipe symbols ‘|’ separate the atomic functions 101 making up the levels 110 within the composite function 401. In the initial form of the expression 400, it is assumed that a quantity 145 and an extent 140 are known only for the vDisk node 111 at the top. Moving from line to line, the equilibration rules above are applied to fill in the quantity 145 and extent 140 at each level 110 from left to right in the expression. Between each pair of lines is a downward arrow 404 next to which are shown the rule(s) applied in that step. While we moved from left to right in this example, the same approach based on the rules can be used to fill in quantities 145 and extents 140 at all levels 110 to be populated starting from any one known node quantity 145 and any one known extent 140, not necessarily associated with the same level 110.

### Identity Functions

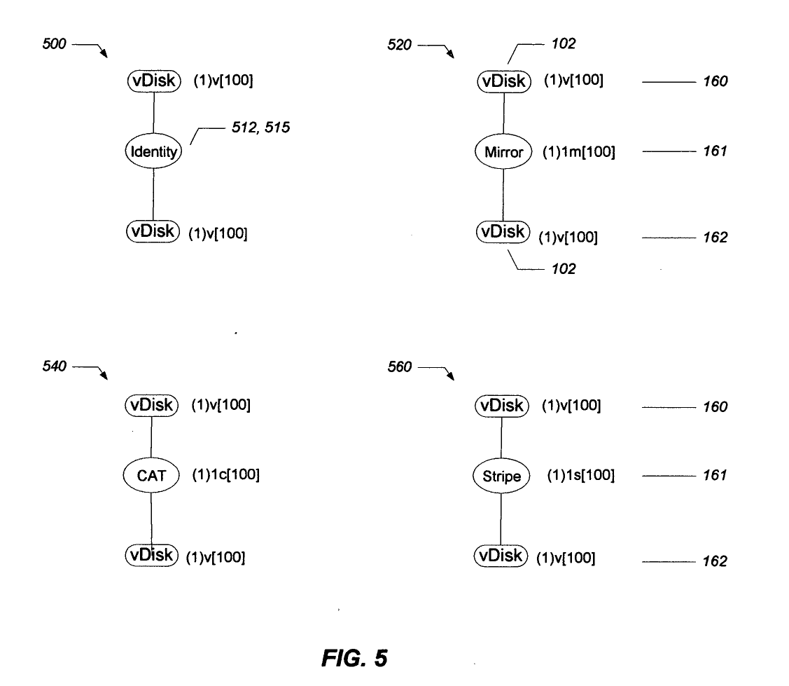

Each of the four SV trees 100 in FIG. 5 shows a function at level 1 161 that maps a source vDisk node 111 in level 0 160 into an identical target vDisk node 111 in level 2 162. This is the definition of an SV identity function 512, as explicitly depicted as an identity node 515 in the upper left tree 500. The remaining three SV trees 100 ( 520, 540, and 560) demonstrate that any core SV atomic function 101 having a fan number 155 equal to one is an identity function 512. (For these function types 150, the fan number 155 is always a positive integer.) For example, a mirror function 122 that maps one vDisk 102 unit into an identical vDisk 102 unit has performed an identity mapping. Consequently, a CAT function 121, stripe function 123, or mirror function 122 can be inserted into, or removed from, anywhere within any SV tree 100 with impunity, so long as its fan number 155 is one. As will be seen later, this seemingly trivial fact often plays an important role in manipulations using the invention.

### Manipulations of Adjacent Atomic Functions

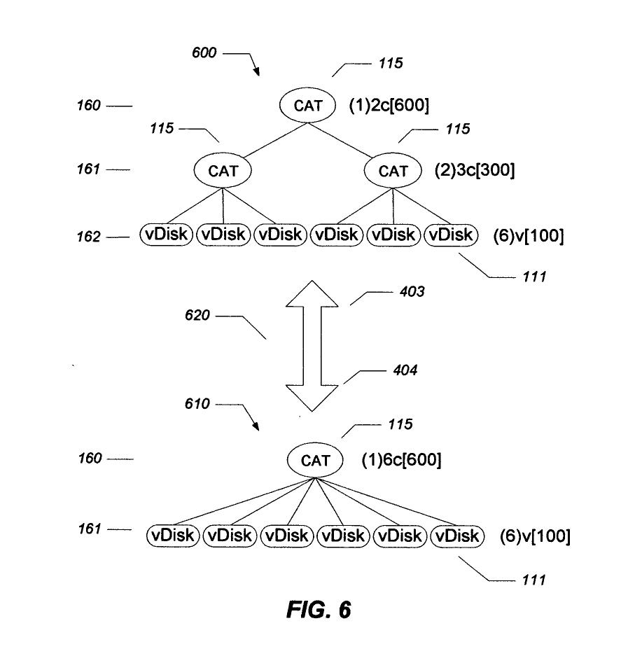

Rules for manipulating SV atomic functions in adjacent levels 110 of an SV-balanced tree 180 are key to the power of the invention. For the 3 core atomic functions 101, there are 9 possible configurations of adjacent pairs (namely cc, cs, cm, sc, ss, sm, mc, ms, and mm). Adjacent levels of the same function type 150 can be combined into a single level 110; adjacent levels 110, whether or not of the same function type 150, may be swapped for convenience. All such adjacent pair manipulations turn out to have inverses. For example, the conversion from sc to cs is the inverse of the conversion from cs to sc. Manipulations of all possible pairings have consequently been captured in only 6 diagrams, FIG. 6-11. Moreover, any transformation formed by successive combining and/or swapping steps also has an inverse.

FIG. 6-8 demonstrate that a pair of adjacent levels 110 of like type 150 can be collapsed into a single level 110 of that type 150. The upper tree 600 of FIG. 6 has CAT nodes 115 in adjacent levels 110. The CAT node 115 in level 0 160 has a fan 155 of 2 and an extent 140 of 600. As discussed previously, the extent 140 of a child of a CAT node 115 is equal to the extent 140 of the parent (600) divided by the fan 155 of the parent (2), so the nodes 105 in level 1 161 have an extent of 300. Similarly, the vDisk nodes 111 in level 2 162 each have an extent of 100 (=300/3). For any core atomic function 101, the quantity 145 of nodes 105 at a child level 110 is equal to the quantity 145 at the parent level multiplied by the fan 155 of the parent node 105. The lower tree 610 is equivalent to the upper one 600, illustrating that a parent node 105 of a given type in level L can be combined with child nodes 105 in level L+1 having the same type 150. The fan 155 of the parent (here 2) multiplied by the fan 155 of the child (3) nodes 105 is equal to the fan of the combined node 105 (6). The extent 140 of the parent node 105 (here 600) will be equal to the extent 140 of the combined node 105 (600).

The combination of two adjacent function nodes 114 of like type 150 always has an inverse, indicated by the upward arrow 403 portion of the double arrow 620 in FIG. 6. In the figure, the fan number 155 of the upper CAT level 170 is 2, which requires that the lower CAT level 170 must have a fan 155 equal to 3 to correspond with the 6 target vDisk nodes 111. Note that the CAT level 170 in the lower tree 610 could be split into two CAT levels 170 in three other ways, characterized by the fan number 155 of the resulting upper CAT level 170. The other possible fan numbers 155 for the upper level 110 are 3, 1, and 6, which correspond to fans 155 in the lower level 110 of 2, 6, and 1, respectively. In general, when splitting any atomic function 101 node into two levels 110, the product of the two resulting fans 155 must be equal to the number of children of the node 105 being split.

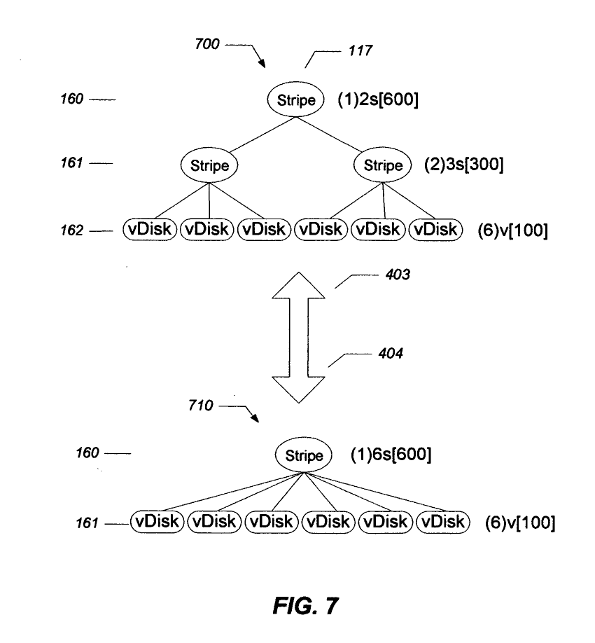

FIG. 7 illustrates that adjacent levels 110 of stripe nodes 117 combine in all respects analogously to the CAT function illustrated in FIG. 6. The details of the figure require no further explanation. However, it should be noted that the distribution of data on the target vDisk 102 could be affected by the stripe and strip size parameters in the two levels 110 of stripe nodes 117. This will be explained in more detail in the subsection entitled “Tracing with Multiple Stripe Levels”.

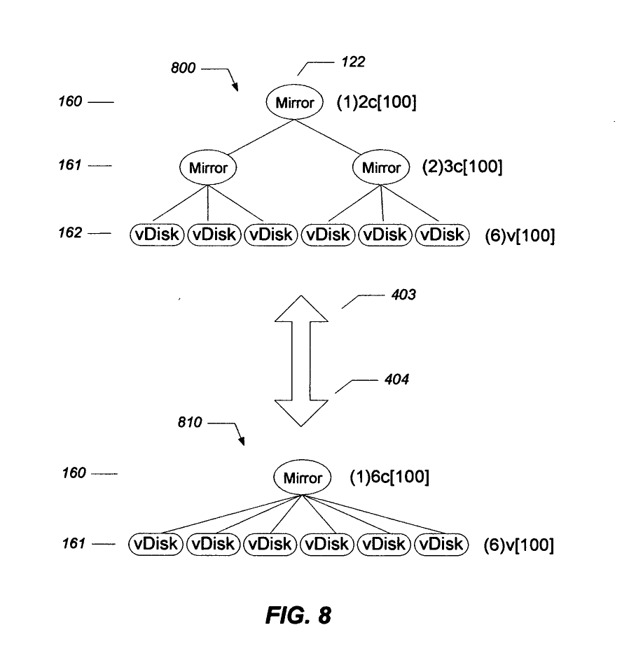

FIG. 8 shows that there is one difference in how adjacent levels 110 of mirror nodes 116 combine from the comparable CAT node 115 and stripe node 117 cases illustrated in the two preceding figures. This distinction derives from the fact discussed earlier that source and target nodes 105 of a mirror function 122 have identical extents. Consequently, all nodes 105 in both SV trees 100 in the figure have the same extent 140 (i.e., 100).

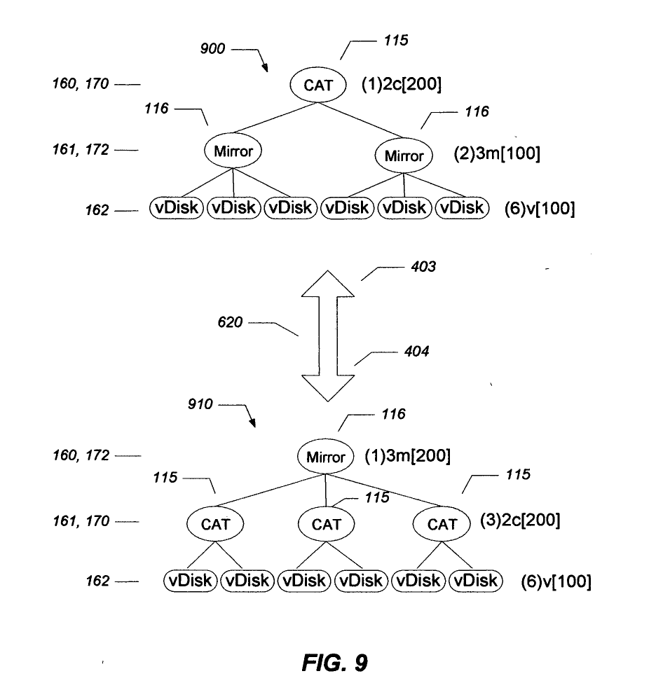

The next three figures demonstrate the effect of swapping adjacent levels 110 containing function nodes 114 of unlike type 150. FIG. 9 illustrates that a CAT level 170 over a mirror level 172 (cm) can be swapped to a mirror level 172 over a CAT level 170 (mc). Each of the atomic functions 101 retains its respective fan number 155 after the swap—the 2-way CAT node 115 that was at level 0 160 before the swap transforms into a level 110 of 2-way CAT nodes 115 in level 1 161. Similarly, the 3-way mirror level 172 moves from level 1 161 up to level 0 160. When level L and level L+1 are swapped, then level L has the same quantity 145 of nodes 105 after the transformation as before. In the figure, level 1 161 has one CAT node 115 before and one mirror node 116 after the transformation. The resulting quantity of nodes in level L+1 (here 3) is equal to the quantity 145 in level L (1) multiplied by the fan 155 of the new parent node 105 (3).

In swapping adjacent levels 110 of unlike types 150, the extents 140 of the nodes 105 must be adjusted to maintain equilibration. One approach is to apply the equilibration rules discussed previously in connection with FIG. 3 directly. In applying these rules to the extents 140 shown in the lower tree 910 after the transformation from cm to mc, we start with the fact that the extent 140 (100) of target vDisk nodes 111 in level 2 162 are unchanged by the swap. Because the extent 140 of a child of a CAT node 115 (here 100) is equal to the extent 140 of the CAT node 115 (2) divided by the fan 155 of the CAT node 115, it follows that the extent 140 of the CAT level 170 in level 1 161 must be 200. The extent 140 of the root node has remained unchanged as required.

A second approach to making extent 140 adjustments after a level 110 swap is to successively apply “moving up” and “moving down” rules that can be inferred from FIG. 3 and related discussion, and will be stated here without proof. The moving up rule states that if f and g are core function types 150 in adjacent levels 110, then to move g up to the level 110 of f: if f is a level of CAT nodes 115 or stripe nodes 117 (as in transforming from cm to mc), then multiply the extent 140 of g (here 100) by the fan 155 of f (2); otherwise, g keeps its old extent 140. Divide the quantity 145 of the g nodes 105 (here 2) by the fan 155 of f (2). The moving up rule correctly results in one mirror node 116 in level 0 160 of the lower tree 910 having an extent 140 of 200. The moving down rule holds that if g is a CAT level 170 or a stripe level 171, then divide the extent 140 of f by the fan 155 of g when it moves down one level 110. Otherwise (as here), f keeps its old extent 140 (200). Multiply the initial quantity 145 of f nodes 105 (here 1) by the fan 155 (3) of g to obtain the resulting quantity 145 of f nodes 105. The moving down rule correctly results in 3 CAT nodes 115 of extent 140 200 in level 1 161 of the lower tree 910.

We now consider the inverse operation (i.e., mc to cm), working backwards from the lower tree 910 in FIG. 9 to the upper one 900. Applying the moving up and down rules, we again regard the swap as a two-step process. First, the CAT level 170 moves up to the level 110 of the mirror function 122. The extent 140 of the moving up CAT level 170 (i.e., 200) is unchanged because it starts below a mirror node 116. The new quantity 145 (1) of CAT nodes 115 is equal to the old quantity 145 (3) of CAT nodes 115 divided by the fan 155 (3) of the parent mirror node 116. Second, the mirror function 122 moves down below the CAT node 115, so its extent 140 (i.e., 200) is divided by the fan 155 of the CAT node 115 (2), resulting in an extent 140 of 100. The new quantity 145 of mirror nodes 116 (2) is equal to the quantity 145 of new parent CAT nodes 115 (1) multiplied by the fan 155 of the parent (2).

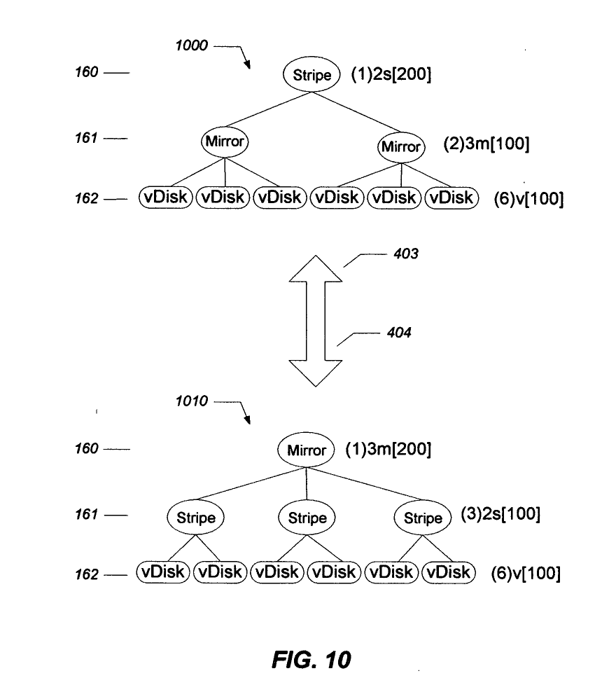

FIG. 10 illustrates swapping from an sm SV tree 100 to an ms tree (downward arrow 404), and conversely (upward arrow 403). Because of the similarity of relevant behavior between CAT functions 121 and stripe functions 123, this figure is identical to the previous one in all material respects and will not be discussed.

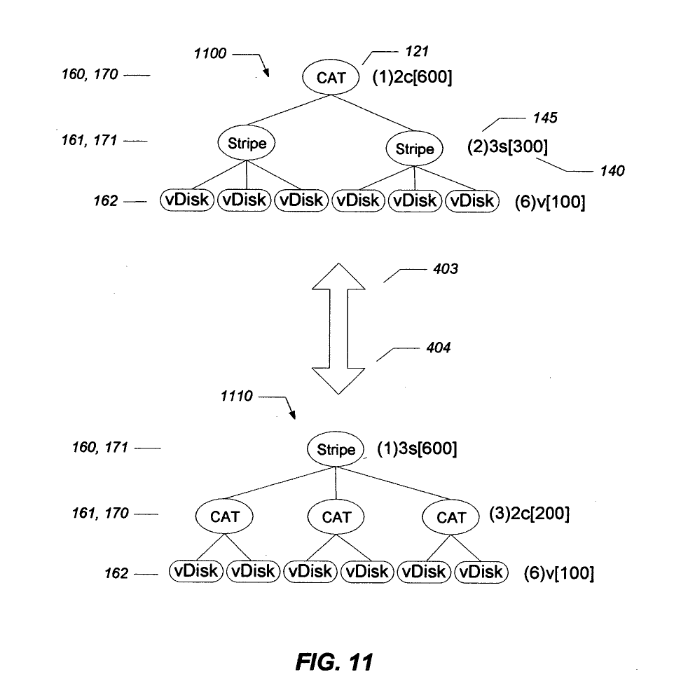

FIG. 11 demonstrates swapping between a cs (upper 1100) SV tree 100 and an sc (lower 1110) SV tree 100. The behavior of node quantities 145 as a consequence of the swap here is just like the previous two figures, so our discussion will be limited to the distribution of extents 140 among levels 110, which is a somewhat different in this case. In transforming from the top tree 1100 to the 1110 lower tree, the swap is again a two-step process. The stripe level 171 first moves up to the CAT level 170, requiring a multiplication of the extent 140 of the stripe function 123 (300) by the fan 155 of the CAT level 170 (2), resulting in a stripe node 117 at level 0 160 having an extent 140 of 600 in the lower diagram 1110. The second step is for the CAT level 170 to move downward below the stripe level 171. This requires that the extent 140 of the CAT level 170 (600) be divided by the fan 155 (3) of the stripe node 117, resulting in an extent 140 of 200. The inverse operation (up arrow) is similar, and will not be discussed.

### Rules for Identity Functions and for Adjacent Level Manipulations

From figures previously discussed, the following rules can be deduced about manipulating adjacent layers in SV-balanced trees 180. Let levels 110 level L and level L+1 containing f-nodes and g-nodes, respectively.
A1—(identity functions) Any SV atomic function with a fan 155 of 1 can be inserted into, or removed from, any point within the tree.
A2—(swapping adjacent levels) To swap adjacent levels where f and g are the same or different types 150, first apply the “moving up” rule (A4) to the g-nodes. Then apply the “moving down” rule to the f-nodes. The f-nodes and g-nodes each retain their respective fan numbers 155.
A3—(combining adjacent levels 110 of like type 150) To combine adjacent levels 110 where f and g are the same type 150, apply the moving up rule to the g-nodes. The fan number 155 of the combination is equal to the fan 155 of the f-nodes multiplied by the fan 155 of the g-nodes. Then level L+1 is eliminated. The quantity 145 of nodes 105 in level L is unchanged (i.e., the quantity 145 of nodes after the combination is equal to the quantity 145 of f-nodes before).

A4—(moving up) If f has type of CAT 118 or stripe 120, then multiply the extent 140 of the g-nodes by the fan 155 of the f-nodes. Otherwise, the g-nodes keep their old extent 140. Divide the quantity 145 of g-nodes by the fan 155 of the f-nodes.

A5—(moving down) To move the f-nodes down: if g has type of CAT 118 or stripe 120, then divide the extent 140 of the f-nodes by the fan 155 of the g-nodes. Otherwise, the f-nodes keep their old extent 140. Multiply the quantity 145 of f-nodes by the fan 155 of the g-nodes.

A6—(inverses) The steps of combining adjacent levels 110 of like function type 150 and swapping adjacent levels 110 of any function types 150 are invertible.

### Normalization Method

The rules for manipulation of adjacent levels 110 allow us to now demonstrate that any given composite function 401 (i.e., a composite function 401 corresponding to a SV-balanced mapping) can be converted to SV-normal form. The method used in the proof also provides an efficient process for converting to SV-normal form, although not the only one. For this purpose, it is more convenient to think of the mapping in algebraic notation (e.g., (CAT|stripe|mirror|stripe| . . . )) rather than in SV tree 100 form. Suppose that the given composite function 401 contains the core function type 150 f, say at levels L and M in the composition 401, such that level L is to the left of level M; also assume that there is no level 110 of the type 150 of f between levels L and M. If levels L and M are adjacent levels, then they can be combined according using rule A3. Otherwise, let n=M−L. Then applying n-1 swaps according to rule A2 will make layer level M-1 contain nodes 105 of type 150 f, so level M-1 and level M can now be combined with rule A3. Such combination eliminates a level 110. This process can be repeated to reduce the instances of each core function type 150 to at most one and the number of levels to at most three. If any of the core function types 150 is not represented in the resulting composition 401, then an identity function 512 of each missing type shall be inserted by applying rule A1. At this point, if the 3 levels 110 in the composition 401 are not already in SV-normal form (e.g., CAT function 121 over mirror function 122 over stripe function 123), they can be rearranged accordingly using swapping rule A2. This completes the proof.

Note that the above method permits one to readily achieve any ordering of the 3 core function types 150, so any such ordering is a viable choice for an SV-normal form. While there does not seem to be any reason to choose an SV-normal form other than one based on the 6 possible orderings of the 3 core functions, the ability to use these same manipulation rules to convert a given function to various non-SV-normal forms will be seen below to be useful for splitting RAID functionality across SV subsystems and for converting to local non-normal forms required by some specific devices. It is obvious that a form that does not include at least one level 110 of each atomic function type 150 cannot serve as a general purpose SV-normal form.

### Composite Function Normalization Example

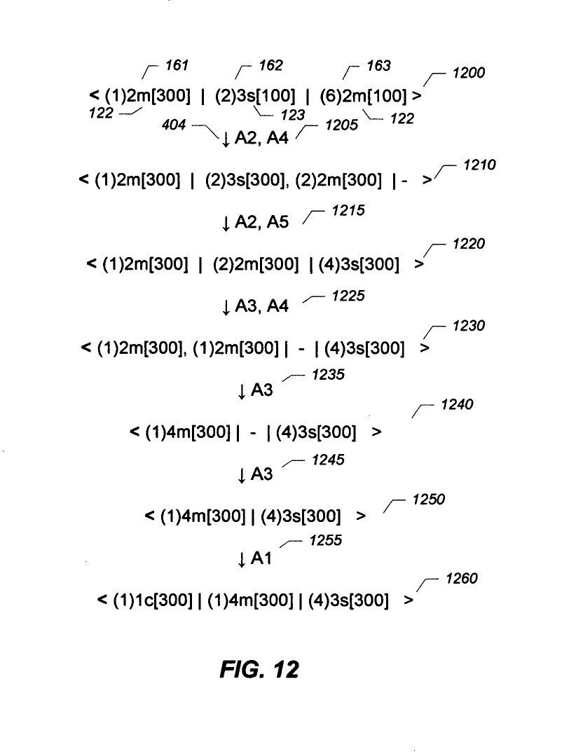

FIG. 12 illustrates a sequential application of the level manipulation rules (A1-A6) to convert an initial composite function 401 in algebraic form 1200 into a final one 1260 that is in SV-normal form. SV trees 100 corresponding to the initial 1300 and final 1310 composite functions 401 are shown in FIG. 13. So that the level 110 numbers correspond between the two figures, we will refer to the three levels 110 of the composite function 401 as level 1 161, level 2 162, and level 3 163, respectively.

The rules applied in each step in the normalization process are indicated in FIG. 12 just to the right of the downward arrow 404 between successive forms of the composite function 401. To begin the conversion to SV-normal form, atomic functions 101 of like kind are made adjacent by swapping, and then combined. Noticing that the initial composite function 1200 has mirror functions 122 in level 1 161 and level 3 163, we swap the stripe function 123 in level 2 162 with the mirror function 122 in level 3 163 to make the two mirror functions 122 adjacent. This swap also has the advantage of placing the stripe function 123 into the lowest level 110, in conformance with the preferred SV-normal form. Rule A2, which governs swaps of adjacent functions, first requires that we apply 1205 the moving up rule (A4) to the mirror function 122 in level 3 163. The result 1210 indicates that two atomic functions 101 now share level 2 162, while level 3 163 is temporarily vacant. Also according to rule A4, the quantity 145 of mirror nodes 116 (6) has been divided by the fan 155 of the stripe function 123 (3), resulting in 2 mirror nodes 116 at level 2; and the extent 140 of the mirror function 122 (100) has been multiplied by the fan 155 of the stripe function 123 (3), resulting in an extent 140 of 300 for the mirror nodes 116 at level 2 162.

According to rule A2, the moving down rule A5 is now applied 1215. Because the stripe function 123 is moving below a mirror function 122, its extent 140 remains the same (300), and its node quantity 145 (2) is multiplied by the fan 155 of the mirror function 122 (2), thereby becoming 4 in the composition 1220. Rule A2 also requires that both the mirror function 122 and the stripe function 123 retain their fan numbers 155 (2 and 3, respectively), through the swap.

In converting 1225 from composition 1220 to 1230, rule A3 for combining nodes 105 is applied, first triggering the moving up rule A4. This results in two mirror nodes 116 in level 1 161, while level 2 162 is temporarily vacant. The quantity 145 of the mirror nodes 116 moving up (2) is divided by the fan 155 of the mirror node 116 in the parent level 110 (2), resulting in a quantity 145 of 1.

In converting 1235 from composition 1230 to 1240, rule A3 is further applied to combine the two mirror functions 122 in level 1 161. The result takes its node quantity 145 (1) and extent (300) from the former parent. The fan number 155 (4) is obtained by multiplying the fan numbers 155 of the functions being combined (here, both 2).

According to rule A4, to convert composition 1240 to 1250, the vacant level 2 162 now gets eliminated. In transforming composition 1255 to 1260, an identity function 512 in the form of a CAT function 121 having a fan number 155 equal to 1 is added. At this point, the composite function 401 is finally in SV-normal form, consisting of a CAT function 121 followed by a mirror function 122 followed by a stripe function 123. It is also fully equilibrated.

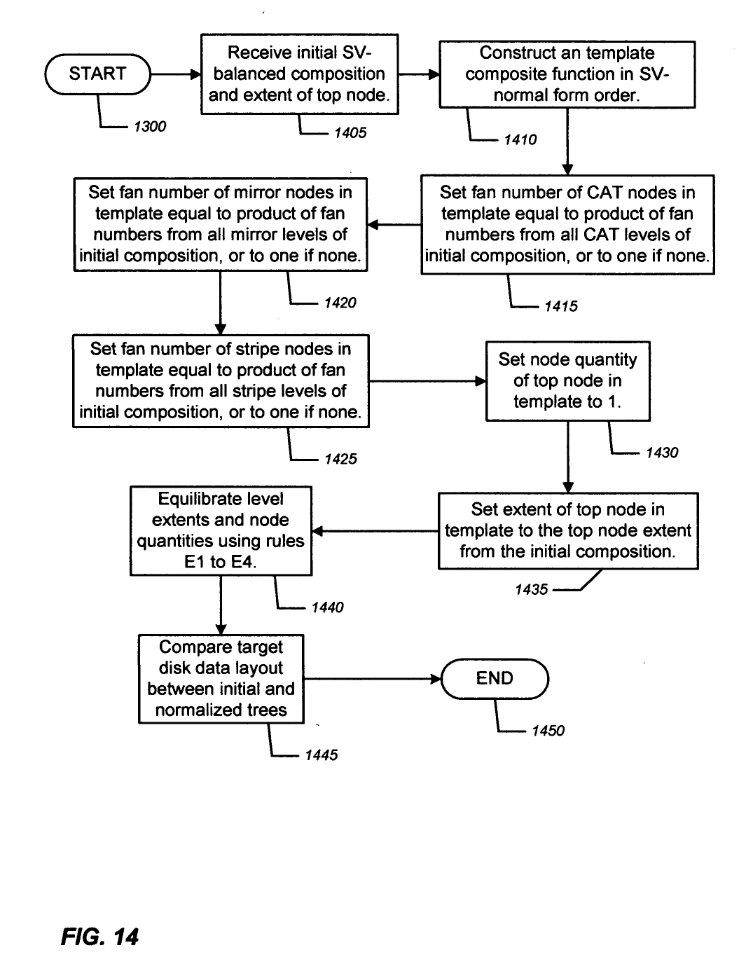

FIG. 13 depicts a vDisk node 111 in level 0 160 mapped into 12 pDisk nodes 112 (numbered p1 through p12) in level 4 164 by the initial (upper tree 1300) and SV-normal form (lower tree 1310) composite function 401 forms from FIG. 12. Either the process from FIG. 12 or the one from FIG. 14, which will be discussed next, can be used to achieve and equilibrate this transformation. This figure shows extents 140 of the nodes 105 at each level 110 in square brackets to the right as typified by the labeled extent 140 on the mirror node 116 of the upper tree 1300.

Notice that in FIG. 12, the equilibration of extents 140 and node quantities 145 was maintained at each step in the transformation process. A much simpler method for transforming to SV-normal form and equilibrating the result is shown in FIG. 14. An initial SV-balanced composition is received 1405 having some known extent 140 for the top node 105. A template for an SV-normal form composition is constructed 1410. The template has the correct sequence of atomic functions 101 (e.g., CAT|mirror|stripe), but no values of fan numbers 155, quantities 145, or extents 140. In the next three steps (1415, 1420, 1425), the fan numbers 155 are filled into the template. These three steps can be done in any order. Step 1415 is typical. The fan number 155 for the CAT level 170 in the template is 1 if the initial composition has no CAT levels 170; otherwise, it is the product of the fan numbers from all the CAT levels 170 in the initial composition. In step 1430, the top node 105 in the template is given 1430 a quantity 145 of 1. Then, the top node 105 in the template is given 1435 an extent 140 equal to its counterpart in the initial composition. Then the equilibration rules E1-E4 are applied 1440 to the template, as were illustrated in FIG. 4. At this point, the composition is in SV-normal form and is fully equilibrated. Finally, a comparison is optionally done 1445 with respect to target disk layout between the initial and final composite functions 401 forms. This last step will be discussed in the next subsection. Note that while the approach of FIG. 14 is a great simplification, the approach of FIG. 12 is still relevant to conversion to forms other than SV-normal form as well as to manipulation of a relatively few levels 110.

### Tracing Target Data Arrangement After Transformation

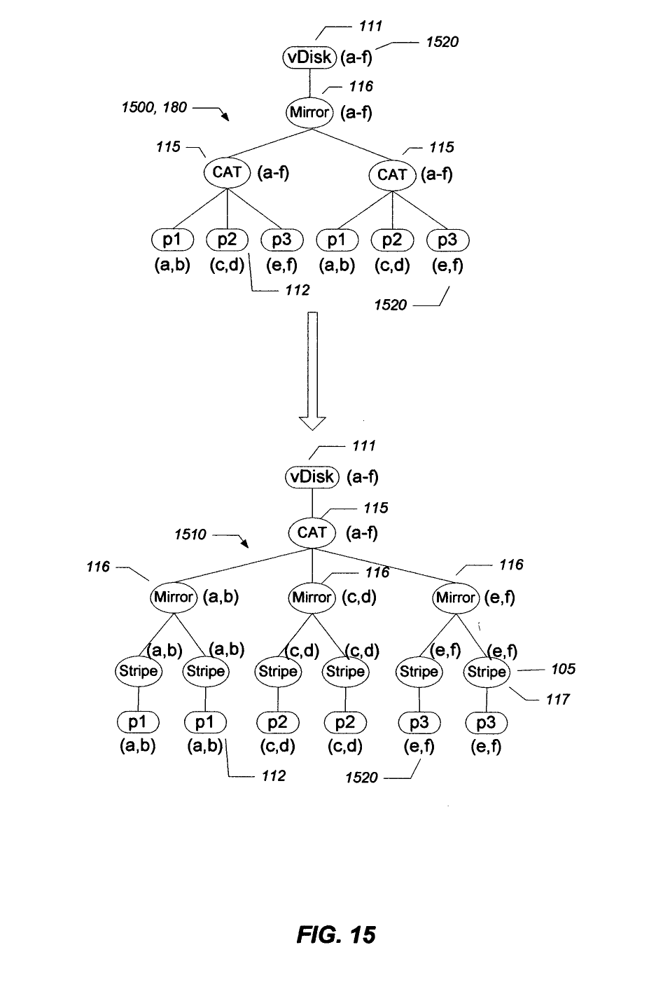

To this point, the discussion has ignored how the arrangement of data on target vDisk nodes 111 (or pDisk nodes 112) by a given composite function 401 (or tree in SV-normal form) relates to that of an equivalent one. In an embodiment of the present invention, logic handles this data tracing for the most important situations, which are depicted in FIG. 15-18.

Suppose f is transformed into g, an equivalent composite function. As will be seen below, distribution of data on target disks by g depends upon whether f involves more than one stripe function 123, and if so, upon details regarding relative stripe and strip size parameters. We will initially consider tracing logic for the more straightforward situations, and then will turn to the handling of a few important stripe function 123 parameter situations.

FIG. 15 is an example showing an application of tracing logic to the transformation of an SV-balanced tree 180 that does not involve any stripe functions 123, so distribution of data on target pDisks 103 follows the basic behavior. The upper tree 1500 has been normalized into the lower tree 1510. To illustrate basic tracking logic, the number of target disk nodes 105 of the SV mapping is first counted; in this case, there are 6 pDisk nodes 112. Then, to the vDisk node 111 at the top of the SV tree 100, a range of distinct labels is assigned equal to that count. While any distinct labels would do for this purpose, for the purpose of illustration, the letters a through f were chosen here. This range of letters will represents the total storage range 1520 of the vDisk node 111 at the top of the SV tree 100. Each letter represents a subrange of equal extent. Each node 105 in the figure has been tagged with a storage range 1520 indicating how data are being mapped by the function nodes 114 down the SV tree 100.

In the upper tree 1500, the storage range 1520 of the mirror node 116(a-f) is the same as that of each of its two children CAT nodes 115 because a mirror function 122 merely makes duplicates of the data. The storage range 1520 of each CAT node 115 in the upper tree 1500(a-f) is equal to the combined range of its children, which must therefore have storage ranges 1520 of (a,b), (c,d), and (e,f), respectively. The lower tree 1510 illustrates the augmentation of a level 110 of one identity node 515 to achieve a composition 401 consisting of consecutive levels 110 of CAT node 115, mirror nodes 116, and stripe nodes 117; that is, a composition 401 in SV-normal form. Because the six added stripe nodes 117 are identity nodes 515, they do not complicate data tracing.

The pDisk nodes 112 in both trees have been numbered to correspond to their respective storage ranges 1520. For example, the storage ranges 1520(a,b) is found in two pDisk nodes 112, so these have both been given the same identifier, namely p1. While each pDisk node 112 in the upper tree 1500 has a counterpart in the normalized tree with the same storage range 1520, it is important to note that they are ordered differently. The disk content tracing logic can compute and automatically compensate for such rearrangements.

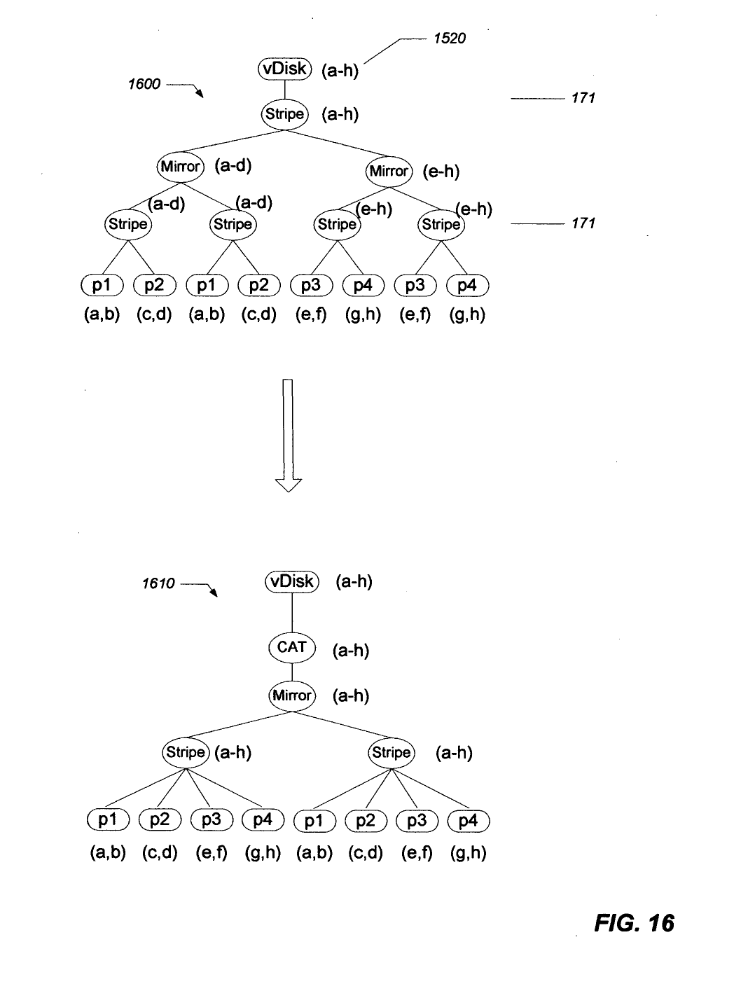

FIG. 16 is another somewhat more complicated example of tracing target data. In this case, the upper tree contains two stripe levels 171, which, as will be described in the next subsection, must be “strongly matched” for the storage range 1520 arrangements shown to be correct.

### Tracing with Multiple Stripe Levels

Consider two distinct stripe levels 171 (levels L and M, where L<M) in an SV tree 100 such that there are no intervening stripe levels 171 between them (other than perhaps identity stripe levels 171). These two stripe levels 171 will termed strongly matched if the strip size of the stripe nodes 117 in level L is equal to the stripe size of the stripe nodes 117 in level M. (See definitions in Background section.) If levels L and M are not strongly matched but have the same strip sizes, then they will be termed weakly matched. If all pairs of stripe levels 171 in an SV tree 100 are strongly matched, then we will refer to the SV tree 100 itself as a strongly matched tree. Similarly, if all pairs are either strongly matched or weakly matched, and at least one pair is weakly matched, then the tree will be termed weakly matched. If at least one such pair is neither strongly nor weakly matched, the SV tree 100 will be termed unmatched.

Swapping or combining adjacent stripe levels 171 (possibly during normalization) of a strongly matched SV tree 100 results in the kind of basic rearrangement of data on target disks illustrated in the previous subsection and FIGS. 15 and 16. Swapping of adjacent stripe levels 171 of a weakly matched SV tree 100 can result in a somewhat different data distribution on the target disks as a consequence of transformation; however, one-to-one correspondence between the individual target vDisk nodes 111 before and after the transformation with respect to contents will exist for this case.

Swapping or combining adjacent stripe levels 171 in an unmatched SV tree 100, in contrast to the strongly and weakly matched cases, can destroy the one-to-one correspondence between individual target vDisk nodes 111 before and after the transformation. The data are all there, just partitioned differently among target disk nodes 105. Even in this case, the resulting atomic functions 101 will have still operated on the data, and the transformation rules still apply. The disadvantage in transforming an unmatched SV tree 100 is that the data cannot remain in place and still be accessed through the new SV tree 100 after the transformation has occurred. The data will have to be run through the new SV tree 100 to populate the target disks.

The invention captures the rules for tracing data distribution resulting from transformation of an SV tree 100 in logic adapted to execution in a digital computer or other electronic device. The basic rules and the special behavior for weakly matched SV trees 100 are derived and integrated into the logic. Being able to anticipate the target data distribution after a transformation is particularly important to automated deployment of SV trees 100 as they evolve over time.

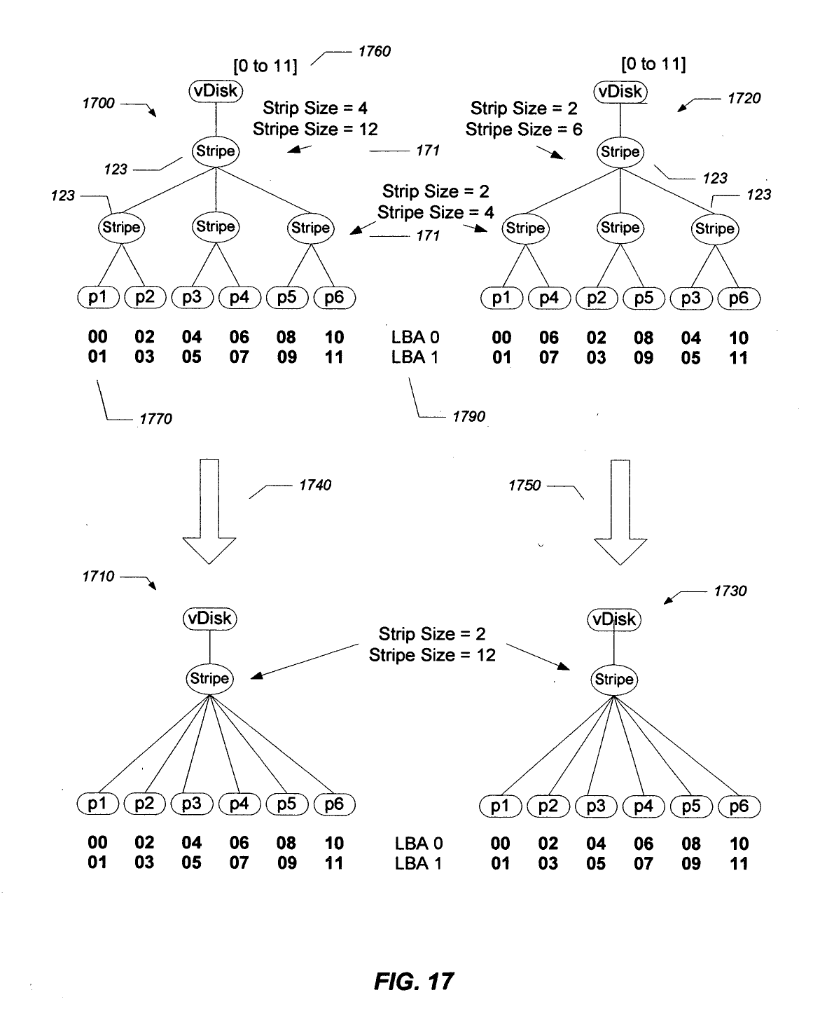

The next two figures illustrate the differences among the strongly matched, weakly matched, and unmatched cases in an example involving combining adjacent stripe levels 171. FIG. 17 depicts two transformations between SV-balanced trees 180. Each initial SV tree 100 (1700, 1720) involves two stripe levels 171 and the trees are only distinct with respect to the parameters of the striping being performed. In the initial tree on the left side (1700), the stripe function 123 at level 1 161 has a strip size of 4 and the stripe function 123 at level 2 162 has a stripe size of 4. Because this is a strongly matched tree, the basic target disk arrangement already discussed applies after the transformation 1740 shown. It is assumed that data have been written to 12 logical block addresses (LBAs) 1760 (numbered 00-11) on the source vDisk node 111 at the top of the SV tree 100. The distribution of data from those source logical blocks 1770 of data onto LBAs of the target disks 1790 is shown below the target pDisk nodes 112 as typified by p1.

The stripe levels 171 in the upper right tree 1720 are not strongly matched because the strip size (2) of the upper stripe level 171 is not equal to the stripe size (4) of the lower stripe level 171. But because the strip size of the upper stripe level 171 is equal to the strip size of the lower stripe level 171, this SV tree 100 is weakly matched. Comparing the distribution of source LBAs across pDisk nodes 112 before and after the transformation 1750 shows that the pDisk nodes 112 are again in one-to-one correspondence with respect to content distribution but appear in a different order. Again, the capability to anticipate the rearrangement due to the transformation is captured in logic that can execute within a digital electronic device. Source code in the C programming language implementing tracing in the basic, strongly balanced, and weakly balanced cases is included in Appendix A.

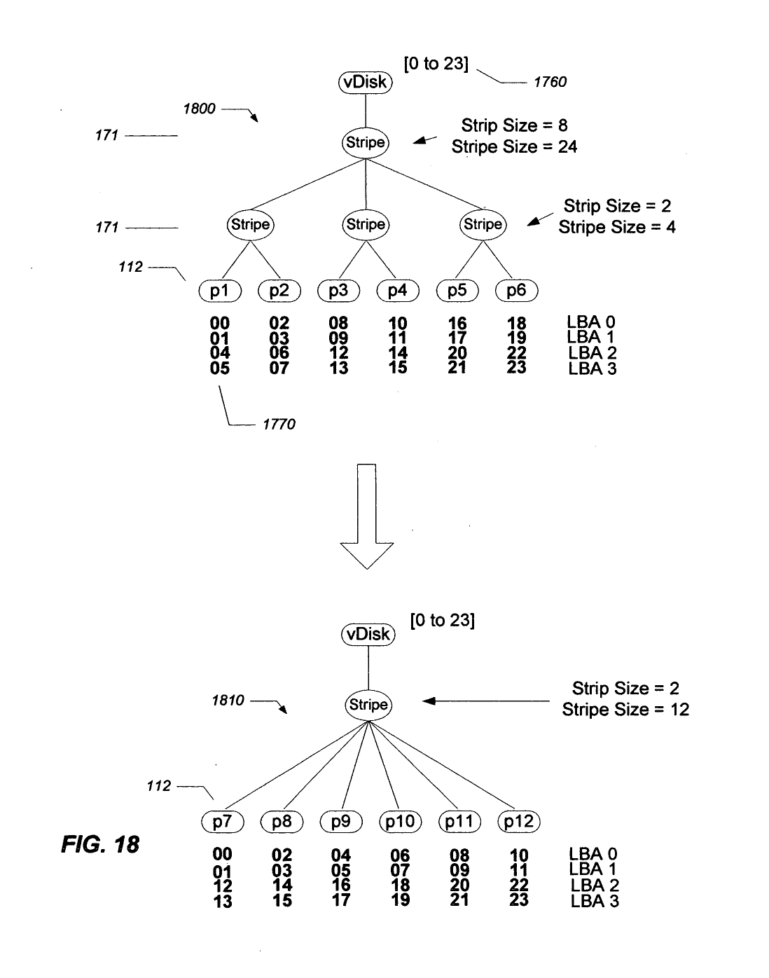

FIG. 18 shows a third transformation in which the initial tree 1800 is structurally the same as that of the two initial trees of FIG. 17. The stripe levels 171 in the upper tree 1800 are not strongly matched because the strip size of the upper stripe level 171 (8) in that tree is not equal to the stripe size of the lower stripe level 171 (4). Nor does this fall into the weakly matched case, since the two strip sizes (8 and 2) differ. As in the previous figure, a range of LBAs associated with the source vDisk node 111 is shown 1760. In this unmatched transformation, unlike all previously discussed cases, none of the target pDisk nodes 112 in the initial SV tree 1800 has a counterpart in the transformed SV tree 1810. This is indicated by the LBAs assigned to the respective pDisk nodes 112. For example, the pDisk node 112 labeled p1 in the upper tree 1800 receives the LBAs 00, 01, 04, and 05 from the source vDisk node 111. In the lower tree 1810, LBAs 00 and 01 are mapped to the target pDisk node 112 labeled p7 (which also contains LBAs 12 and 13). LBAs 04 and 05 wind up on p9 along with LBAs 16 and 17. While normalization of unmatched trees works and provides the comparable functionality and performance comparable to the other two cases, unmatched trees have a disadvantage in that automatic changes of the SV tree 100 are more difficult since data may have to be moved before a transformed SV tree 100 gets activated.

### Adapting an SV Scheme to Storage Subsystem Devices

A composite function 401 can, in theory, consist of any arbitrary sequence of atomic functions 101 having any length. Because reducing a given composite function 401 to practice means actual implementation in hardware or software logic there is an incentive to keep the function sequence simple. Implementation of SV can be done in the host subsystem, the network subsystem (within a Fibre Channel fabric for example), the physical storage subsystem, or some combination of these subsystems. Implementations of more complex SV composite functions 401 are typically (1) harder to design, (2) more expensive to implement, and (3) slower to execute than simpler ones. A key aspect of the invention is the ability to manipulate SV trees into forms that are either simpler or more appropriate for a particular context. A particular embodiment is reduction of SV-balanced trees 180 into an SV-normal form that is readily implemented in hardware. Given a particular choice of SV-normal form, the hardware can be set up to automatically configure itself to any particular instance of that SV-normal form. Such standardization is itself a kind of simplification.

The logic discussed above—e.g., the equilibration method; the rules for swapping, splitting, and combining composite function 401 levels 110; the normalization procedure; and the disk tracking approach—can be incorporated into hardware or software logic. The methods illustrated by FIGS. 4, 12, and 14 are a significant simplification over configuring hardware to handle specific composite functions 401. So long as a required SV mapping, no matter how complicated, is SV-balanced as we have defined that term, it can be reduced to SV-normal form and thereby relatively easily implemented. A family of SV devices for various purposes within each storage subsystem that can all handle SV-normal form for a range of node quantities, fans, and extents would be highly flexible and support automation. The following discussion and figures illustrate embodiments of the invention serving across or within storage subsystems to adapt SV schemes to particular forms, with SV-normal form serving as either an intermediate or a final state.

### The API Stack

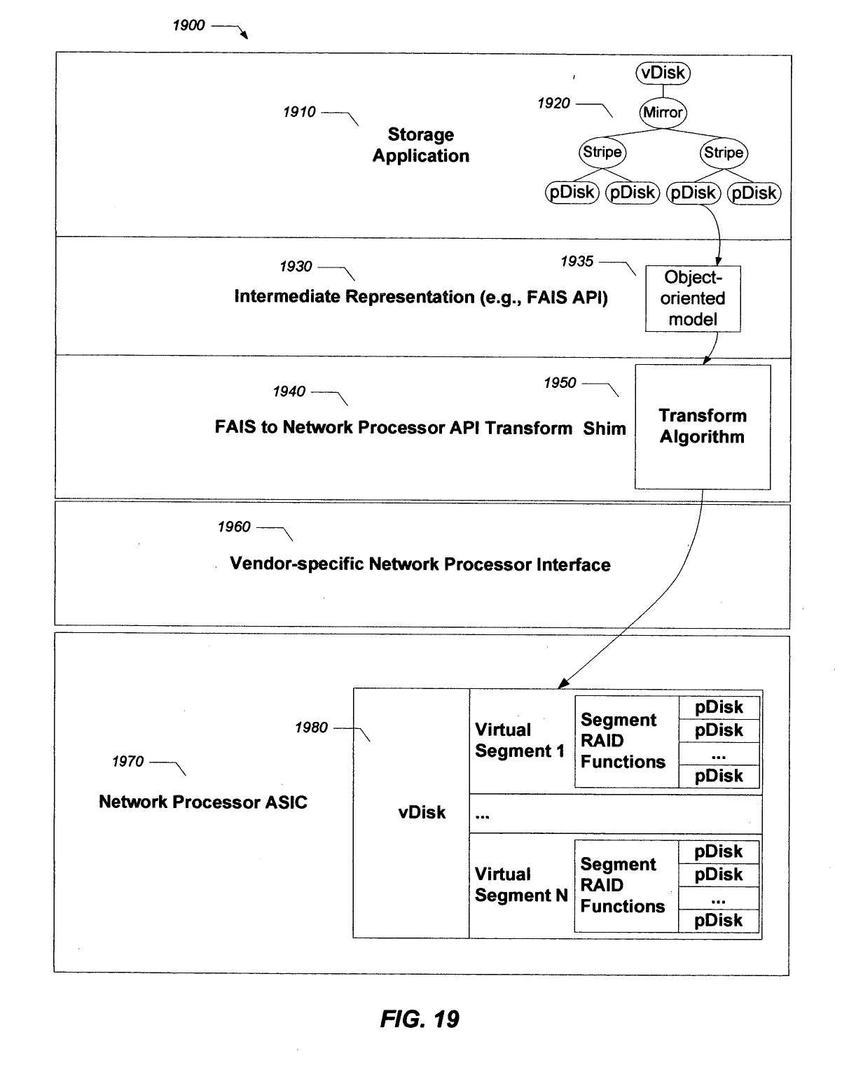

An SV scheme including sequential application of atomic functions 101 including the CAT function 121, stripe function 123, and mirror function 122 can be represented in general in SV tree 100 form. Such an SV tree 100 can be formulated by recursive traversal of an object-oriented (OO) model, such as might be required should FAIS become an accepted standard. FIG. 19 illustrates a structure (an SV stack 1900) and method for utilizing an embodiment of the invention in conjunction with an OO representation such as the model proposed in the FAIS standard. The layers in the SV stack 1900 include a storage application 1910 requiring implementation of an SV scheme 1920 describing an SV tree 100 having arbitrary complexity; an intermediate representation 1930 of the SV tree 100 possibly in an object-oriented (OO) model 1935; at the bottom of the stack, a network processor ASIC 1970 to implement the SV scheme, typically in the form of a network processor mapping table 1980, which will, in general, be incapable of handling the SV scheme 1920 in either its original or its OO form; and, above the network processor ASIC 1970, a vendor-specific network processor interface 1960 that will, in general, be proprietary and hence incompatible with the intermediate representation 1930.

The stack also includes a layer between the intermediate representation 1930 and the network processor interface 1960 in which the invention plays a key role. A transform shim 1940 or adapter (1) transforms the intermediate representation 1930 into an SV tree 100 that the network processor ASIC 1970 is capable of implementing (e.g., some preferred legacy SV tree 100 form) and (2) presents the transformed tree to the network processor interface 1960 in the proprietary form it recognizes. This approach is immediately useful if the SV tree 100 is SV-balanced, but still potentially relevant if the SV tree 100 can be made SV-balanced (see, e.g., FIG. 21 and associated discussion). Another embodiment of the invention is a method that moves an SV scheme 1920 through these layers.

Many other SV stack 1900 embodiments are within the scope of the invention. For example, the intermediate representation 1930 might be omitted, so that the transform shim 1940 operates directly on an SV scheme 1920 specified in tree form; in fact, the transform shim 1940 might be integrated into the storage application 1910. In another embodiment, the network processor ASIC 1970 would accept the SV-normal form of the invention directly, a standardization that could eliminate the need for vendor-specific APIs. Legacy ASIC hardware might be retrofitted by integrating an transform shim 1940 into the network processor ASIC 1970.

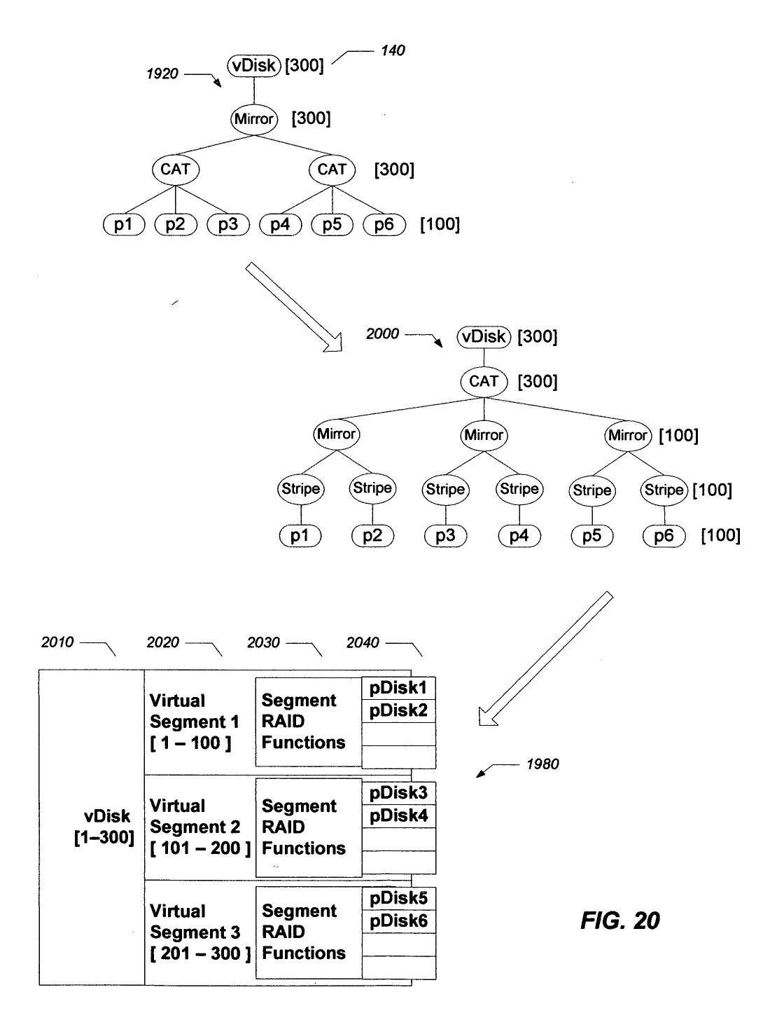

FIG. 20 follows a particular initial SV scheme 1920 to an equivalent SV-normal form 2000, and then to its implementation in a network processor mapping table 1980. In both SV trees 100 at each level, the extent 140 of each node 105 in that level 110 is specified in square brackets to the right of the level 110 as typified by the extent 140 of the vDisk node 111 of the upper tree SV scheme 1920. The network processor mapping table 1980 shows how the SV-normal form 2000 might be represented therein. The first column 2010 shows the vDisk node 111, having an extent 140 of 300. The second column 2020 corresponds to the CAT node 115, showing the initial extent 140 partitioned into 3 virtual segments each having an extent 140 equal to 100. The third column 2030 handles the mirror level 172 and stripe level 171. The fourth column 2040 handles the mapping to pDisks 103.

### SV-Unbalanced Trees

FIG. 21 illustrates an example of an SV-unbalanced tree 190. The tree is unbalanced because the nodes 105 in level 2 162 are not all of the same type 150. Extents 140 associated with each level 110 are shown to the right of the level 110. In this form, the upper tree 2100 as a whole is relatively difficult to manipulate. However, by representing the p1 pDisk node 112 in level 2 162 as the concatenation of two virtual segments p1a and p1b, the SV tree 100 becomes SV-balanced (not shown). The SV-balanced tree 180 can then be converted into an equivalent SV-normal form 2110.

The ability to recognize SV-balanced subtrees embedded within a larger SV-balanced tree and possibly to make manipulate a tree into SV-balance can greatly enhance the usefulness of the invention for a variety of applications, including distribution of SV functionality as described in the next subsection.

### Transformation for Distribution of SV Functionality

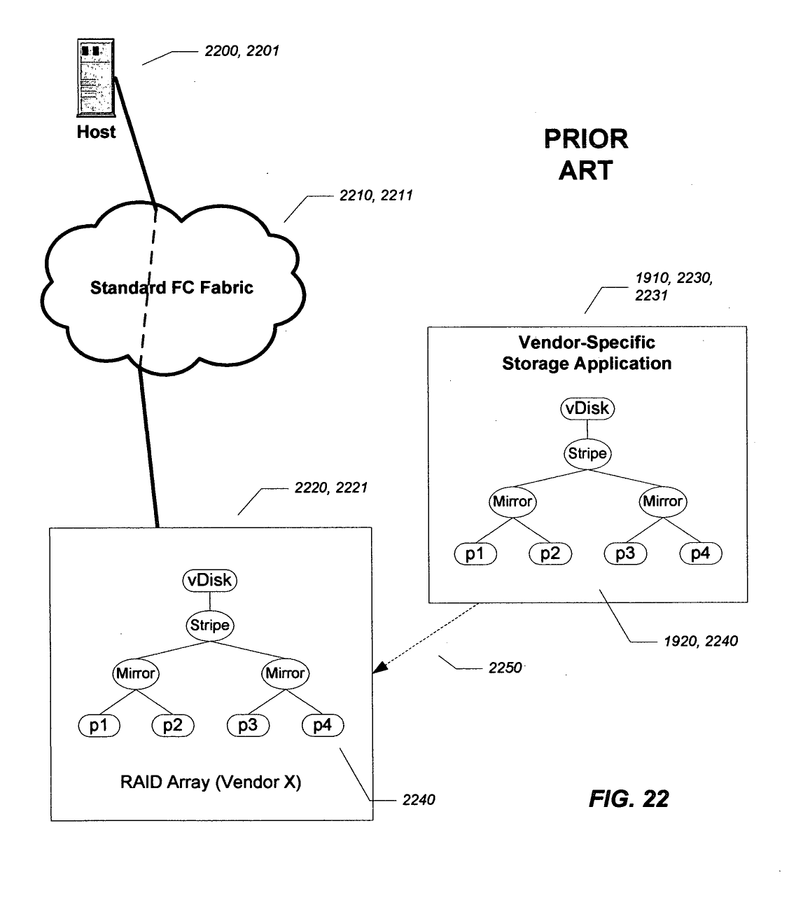

FIG. 22-29 apply the technology of the invention to an SV upgrade that ultimately distributes virtualization functionality between a host subsystem 2200, a network subsystem 2210, and two geographically separated physical storage subsystems 2220. This sequence of figures is illustrative of embodiments of the invention that take advantage of hardware distinctions to better achieve SV goals.

FIG. 22 shows a typical prior art configuration of SV implemented entirely within the physical storage subsystem 2220. The host subsystem 2200 contains a host 2201 computer, connected to the physical storage subsystem 2220 by a network subsystem 2210, which is implemented as a standard Fibre Channel fabric 2211. The physical storage subsystem 2220 contains a proprietary RAID array from Vendor X 2221, which mirrors data, but only at the local site. An SV scheme 1920 in the form of an SV-balanced tree 2240 is specified by a vendor-specific storage application 2231, and pushed out 2250 to the RAID array from Vendor X 2221.

The company wants to switch to Y as its vendor for new storage equipment, possibly because it is less expensive or more reliable. The company expects future growth of data on the host subsystem 2200, and would like to use concatenation to provide scalability within the host subsystem 2200. As part of its disaster preparedness strategy, the company wants its data mirrored to a remote site. Consequently, mirroring must occur outside the proprietary “black box” RAID array from Vendor X 2221, preferably within the network subsystem 2210. This modification also implies that the vendor-specific storage application 2231 must be replaced with a new storage application 1910 that will be able to (1) partition the SV scheme 1920 among subsystems; (2) interface with the proprietary interfaces from both vendors X and Y, as well as with the host subsystem 2200 and the network subsystem 2210; and (3) be easily and preferably automatically reconfigurable to facilitate the company's migration path to offsite mirroring. The following figures show various embodiments of the invention in progressing to the desired deployment.

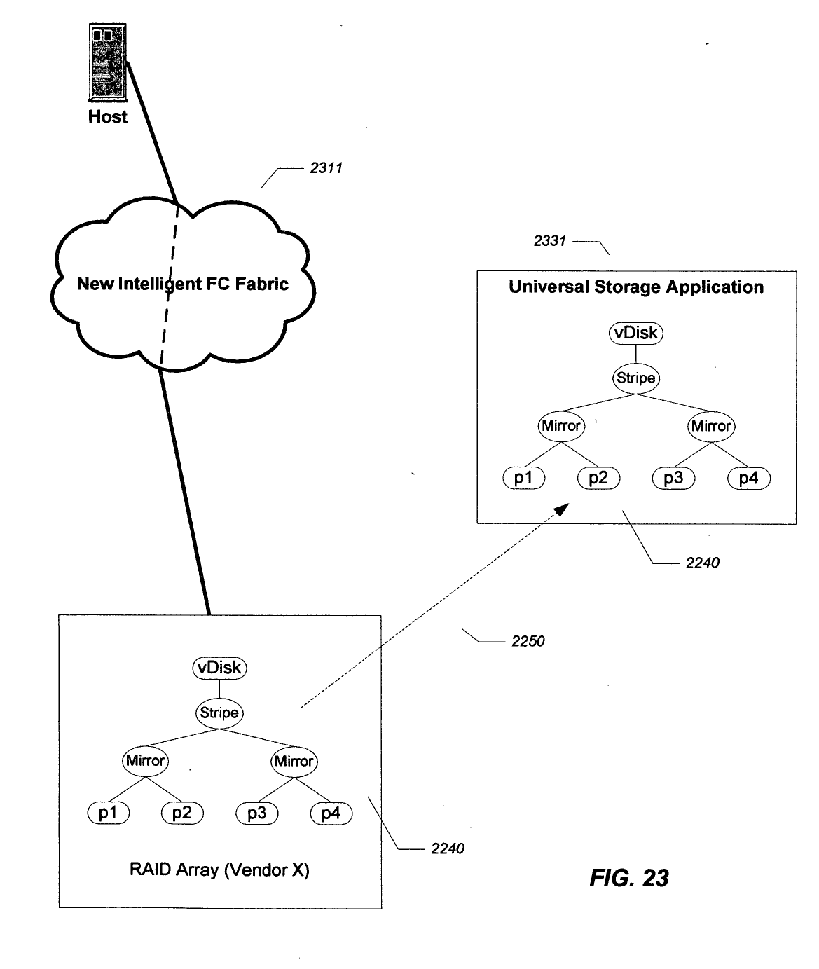

In FIG. 23, the company has acquired a universal storage application 2331 that utilizes various embodiments of the invention for the tasks required for the migration. The SV tree 100 presently being implemented 2240 by the RAID array is input 2250 to the universal storage application 2331. The universal storage application 2331 knows how to interface with and automatically control the SV capabilities of a variety of devices in all three subsystems from various vendors. The universal storage application 2331 implements a toolkit of adapters that embody the invention as described in connection with FIG. 19 to control storage by RAID arrays, fabrics and hosts. The standard Fibre Channel fabric 2211 has been replaced with a new intelligent Fibre Channel fabric 2311 that can execute SV.

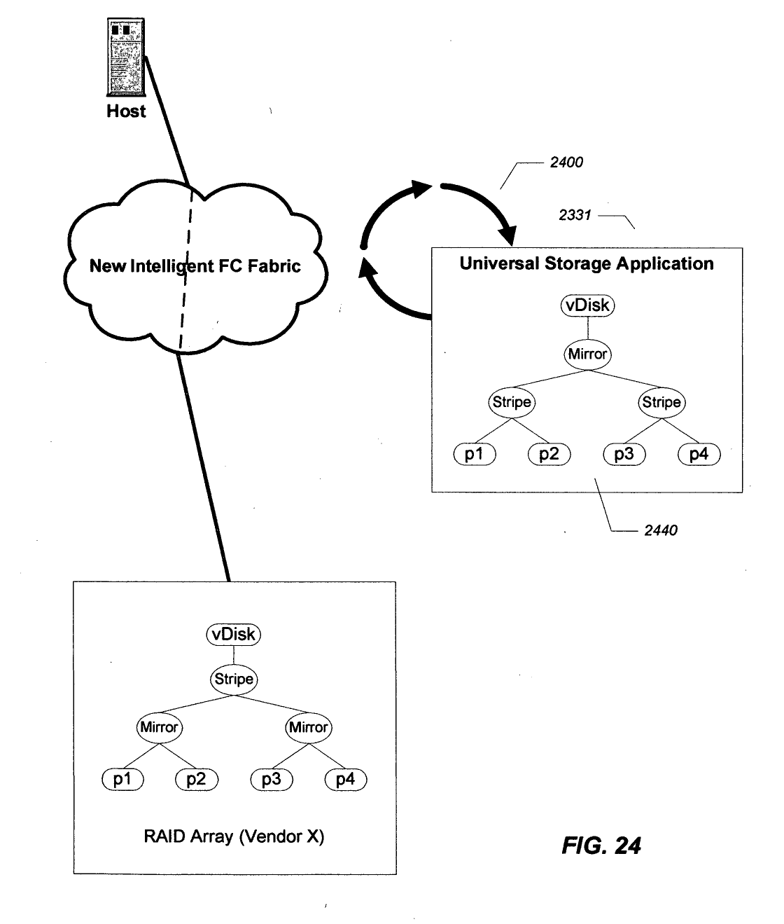

In FIG. 24, the SV tree 100 is transformed 2400 within the universal storage application 2331 into a more convenient form, such as SV-normal form. Actually, the form illustrated 2440 has been chosen to be a slight variant of SV-normal form (wherein the identity CAT node 115 between the vDisk node 105 and the mirror node 116 has been omitted consistently with rule Al above).

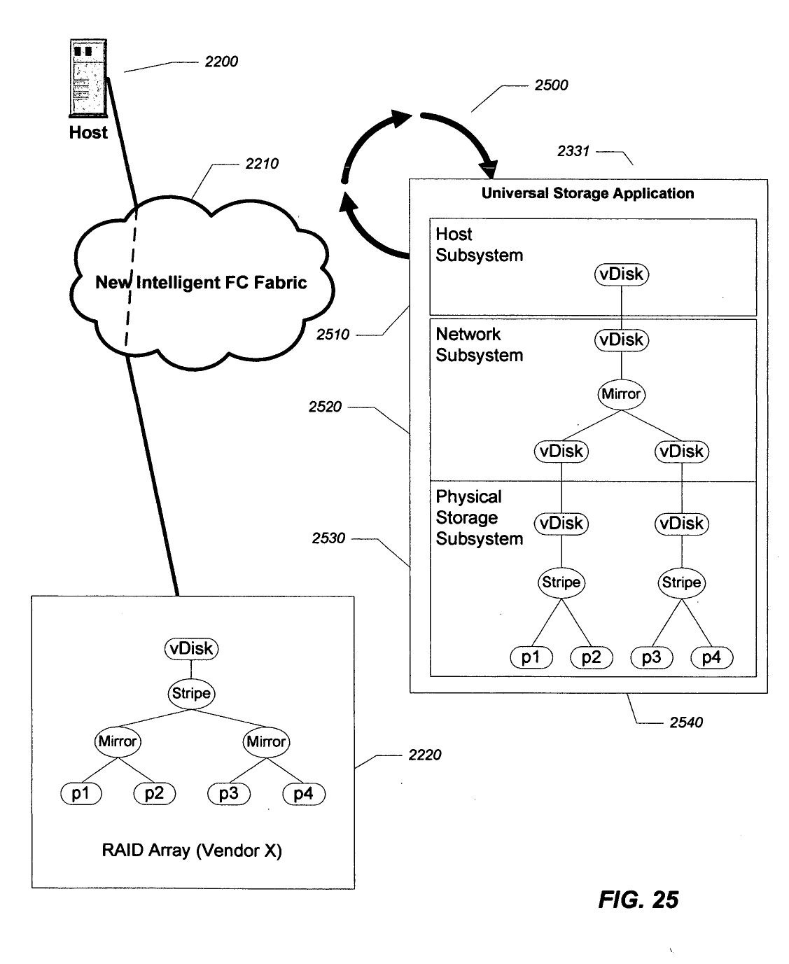

In FIG. 25, the SV tree 100 is partitioned 2500 automatically by the universal storage application 2331 into a host subsystem SV tree 2510, a network subsystem SV tree 2520, and a physical storage subsystem SV tree 2530 for deployment to the three subsystems. The rationale for the preferred choice of SV-normal form (CAT|mirror|stripe) is suggested by this division. Striping is most efficiently done within the hardware of the physical storage subsystem 2220. Mirroring that is performed by the network subsystem 2210 allows redundancy on devices that are physically remote, as we will see in subsequent figures. Concatenation is typically used for allowing the storage needs of the host subsystem 2200 to scale, which argues for concatenation being performed as the first step in SV, either in the host subsystem 2200 or the network subsystem 2210.

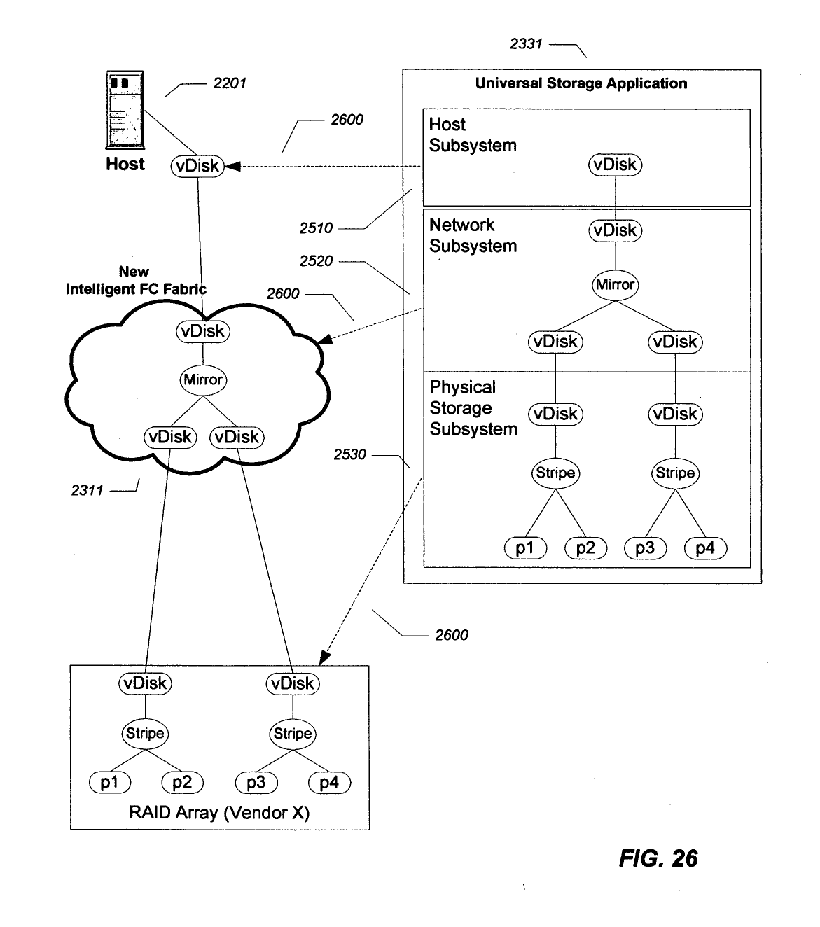

In FIG. 26, the new SV configuration is deployed 2600 by the universal storage application 2331 to each subsystem. Unless the composite function 401 being deployed involves unmatched stripe levels 171, there will be no need to move data before deployment, since the resulting data patterns on the pDisk 103 have not been altered by the transformation of the SV tree 100. Also, all the LUN attributes from the original RAID configuration are now advertised from the intelligent Fibre Channel fabric 2311, so the host 2201 does not perceive any change.

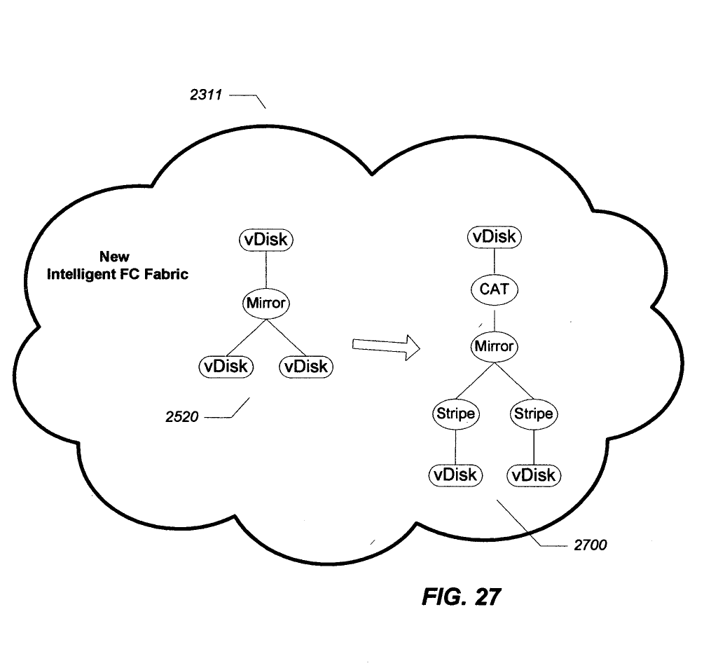

FIG. 27 breaks out the intelligent Fibre Channel fabric 2311 to show an embodiment of the invention transforming the deployed network subsystem SV tree 2520. The fabric can either implement SV-normal form directly, or do yet another conversion to a locally more convenient form. Each subsystem will convert the respective SV tree 100 it has been delegated into a convenient form that is most efficient for its hardware resources, for which SV-normal form is a handy and viable candidate.

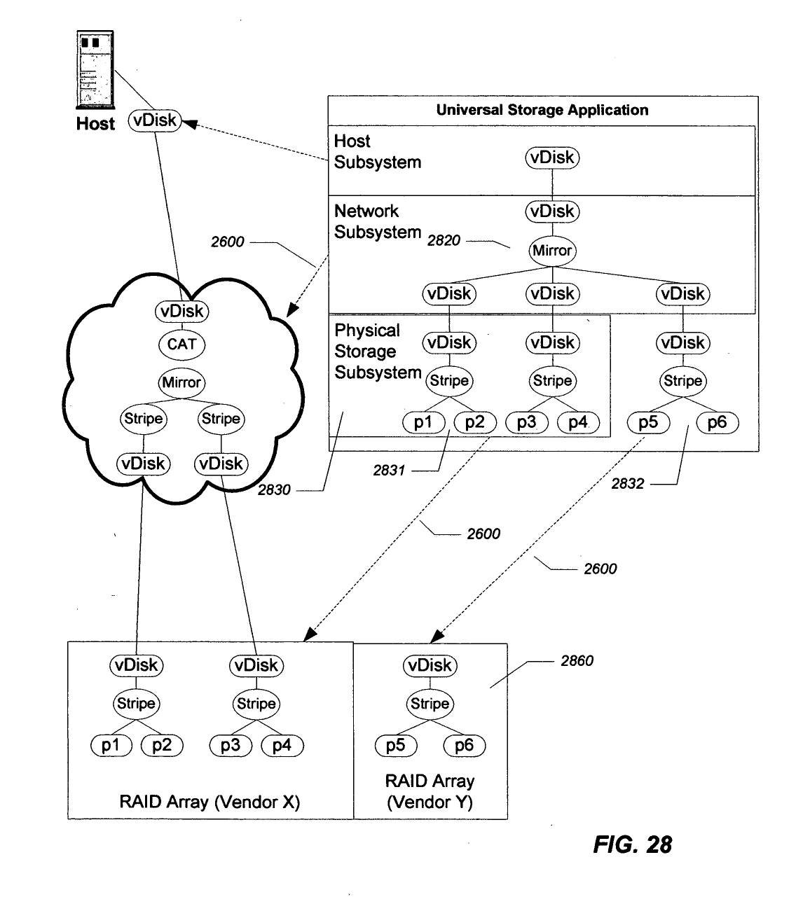

To begin the deployment of the company's new remote mirroring capability (FIG. 28), the SV tree 100 configuration has been modified within the universal storage application 2331, increasing the fan number 155 of the mirror node 116 within the network subsystem SV tree 2820 from 2 to 3. The vendor X RAID tree 2831 within the physical storage subsystem SV tree 2830 remains the same so that local mirroring will continue while the migration is underway. A new vendor Y RAID tree 2832 has been added. The modified SV subtrees are deployed 2600 to the network subsystem 2210 and to the remote mirroring site where a new RAID array from Vendor Y 2860 has been installed. The new third mirror leg must be synchronized with the other two before it is fully functional.

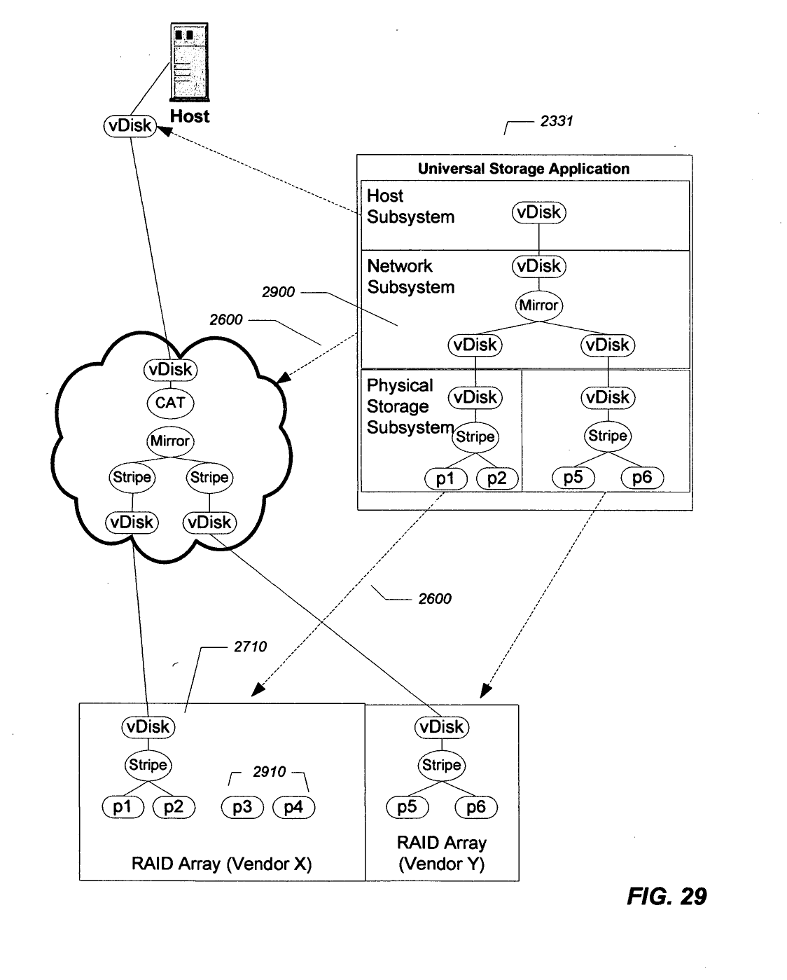

FIG. 29 shows the completed upgrade process. Mirroring has been reduced to two copies again within the universal storage application 2331, but the deployed copies are now geographically remote. The migration process frees up two physical disk units (p3 and p4) 2910.

### Conclusion

The present invention is not limited to all the above details, as modifications and variations may be made without departing from the intent or scope of the invention. Consequently, the invention should be limited only by the following claims and equivalent constructions.

```
APPENDIX A
bool create2dVolStructure( LU_t* lu, int depth,
        full_layout_t* input )
{
    int currentExtent = 0;
    createChildNodes( lu−>diskSize, 0, &lu−>topLevel,
        depth, input );
    labelDisks( lu−>topLevel, CAT, 0);
    labelDisks( lu−>topLevel, MIRROR, 0);
    if( areStripesEqual(lu−>topLevel))
        labelStripeDisks( lu−>topLevel, STRIPE, 1,
            0);
    else
        labelDisks( lu−>topLevel, STRIPE, 0);
    return true;
}
int labelStripeDisks( VVOL_t* node,
    enum FUNCTIONS fun, int levelInc, int levelOffset
    )
{
    VVOL_t* ptr = node;
    int nextLevelInc = 0;
    int shift = 1;
    int levelCount = levelOffset;
    if (ptr−>function == fun)
        nextLevelInc = (levelInc * ptr−>fanOut);// +
            levelCount;
    else
        nextLevelInc = levelInc;
      While ( ptr != NULL )
      {
        if( ptr−>child != NULL )
        }
            labelStripeDisks( ptr−>child, fun,
                nextLevelInc, levelCount );
        }
        else if (ptr−>function == PDISK)
        {
            switch(fun)
            {
                case CAT:
                    ptr−>catID = levelCount;
                    break;
                case MIRROR:
                    ptr−>mirrorID = levelCount;
                    break;
                case STRIPE:
                    ptr−>stripeID = levelCount;
                    break;
            }
        }
        if (ptr−>function == fun)
        {
            levelCount += levelInc;
        }
        ptr = ptr−>next;
      }
    return 0;
}
int labelDisks( VVOL_t* node, enum FUNCTIONS fun, int
        levelCount )
{
    VVOL_t* ptr = node;
    int levelShift = 0;
    int shift = 1;
    // Remember fan out of this level
    if (ptr−>function == fun)
        levelShift = ptr−>fanOut; // − 1;
    while ( ptr != NULL )
    {
        if( ptr−>child != NULL )
        {
            shift = labelDisks( ptr−>child, fun,
                levelCount );
        }
        else if (ptr−>function == PDISK)
        {
            switch(fun)
            {
                case CAT:
                    ptr−>catID = levelCount;
                    break;
                case MIRROR:
                    ptr−>mirrorID = levelCount;
                    break;
                case STRIPE:
                    ptr−>stripeID = levelCount;
                    break;
            }
            levelShift = 1;
        }
        if (ptr−>function == fun)
        {
            levelCount += shift;
        }
        ptr = ptr−>next;
    }
    if(levelShift != 0)
        return levelShift * shift;
    else
        return shift;
}
```

What is claimed is:

1. A method implemented in software or hardware for mapping a source virtual disk (vDisk) to one or more units of target disk, comprising:
a) specifying in advance an SV-normal form sequence wherein each element in the sequence is taken from a set of atomic function types, including the mirror, concatenate, and stripe types;
b) receiving in a digital electronic device an input data structure describing an input SV-balanced tree, wherein an SV-balanced tree contains:
(i) levels of nodes, each level having a single respective type and a single respective fan number, said type and fan number applicable to all nodes in that level,
(ii) a top level having a type of virtual disk (vDisk) and a fan number of 1 and containing a single source vDisk node,
(iii) a bottom level containing target disk nodes, each target disk node having a type of either vDisk or physical disk, and
(iv) at least one intermediate atomic function level having a type taken from the set of atomic function types;
c) inputting the input SV-balanced tree to transform logic executing in the digital electronic device; and
d) transforming by the transform logic the input SV-balanced tree into an output SV-balanced tree having SV-normal form, such that a tree has SV-normal form if:
(i) the number of intermediate atomic function levels is equal to the length of the SV-normal form sequence, and
(ii) the types of the intermediate atomic function levels in order of increasing level number form a sequence identical to the SV-normal form sequence.

2. The method of claim 1, wherein each type in the set of atomic function types appears exactly once in the SV-normal form sequence.

3. The method of claim 2, wherein the SV-normal form sequence is concatenate followed by mirror followed by stripe or concatenate followed by stripe followed by mirror.

4. The method of claim 2, wherein the step of transforming includes:
(i) setting a top level in the output tree to have a type of vDisk,
(ii) setting the bottom level in the output tree to have the same type of nodes as the bottom level in the input tree,
(iii) setting the number of intermediate atomic function levels in the output tree equal to the length of the SV-normal form sequence,
(iv) setting the type of each intermediate atomic function level equal to its positional counterpart in the SV-normal form sequence in increasing order by level number, and
(v) in each intermediate atomic function level in the output tree, if the input tree contains any levels having the same type as said intermediate atomic function level, setting the fan number of said intermediate atomic function level to the product of the fan numbers of the said levels of the input tree, and otherwise setting the fan number of said intermediate atomic function level to one.

5. The method of claim 4, further comprising:
(vi) in each level in the output tree other than the first level, setting the quantity of nodes in that level equal to the quantity of nodes in the previous level multiplied by the fan number of said previous level.

6. A apparatus for mapping a source virtual disk (vDisk) to one or more units of target disk, comprising:
a) an SV-normal form sequence wherein each element in the sequence is taken from a set of atomic function types, including the mirror, concatenate, and stripe types;
b) an input data structure describing an input SV-balanced tree, wherein an SV-balanced tree contains:
(i) levels of nodes, each level having a single respective type and a single respective fan number, said type and fan number applicable to all nodes in that level,
(ii) a top level having a type of virtual disk (vDisk) and a fan number of 1 and containing a single source vDisk node,
(iii) a bottom level containing target disk nodes, each target disk node having a type of either vDisk or physical disk, and
(iv) at least one intermediate atomic function level having a type taken from the set of atomic function types;
c) transform logic in an digital electronic device adapted to transforming the input SV-balanced tree into an output SV-balanced tree having SV-normal form, such that a tree has SV-normal form if:
(i) the number of intermediate atomic function levels is equal to the length of the SV-normal form sequence, and
(ii) the types of the intermediate atomic function levels in order of increasing level number form a sequence identical to the SV-normal form sequence.

7. The apparatus of claim 6, wherein each type in the set of atomic function types appears exactly once in the SV-normal form sequence.

8. The apparatus of claim 7, wherein the SV-normal form sequence is concatenate followed by mirror followed by stripe or concatenate followed by stripe followed by mirror.

9. The apparatus of claim 7, wherein the transform logic is adapted to:
(i) setting a top level in the output tree to have a type of vDisk,
(ii) setting the bottom level in the output tree to have the same type of nodes as the bottom level in the input tree,
(iii) setting the number of intermediate atomic function levels in the output tree equal to the length of the SV-normal form sequence,
(iv) setting the type of each intermediate atomic function level equal to its positional counterpart in the SV-normal form sequence in increasing order by level number, and
(v) in each intermediate atomic function level in the output tree, if the input tree contains any levels having the same type as said intermediate atomic function level, setting the fan number of said intermediate atomic function level to the product of the fan numbers of the said levels of the input tree, and otherwise setting the fan number of said intermediate atomic function level to one.

10. The apparatus of claim 9, wherein the transform logic is further adapted to:
(vi) in each level in the output tree other than the first level, setting the quantity of nodes in that level equal to the quantity of nodes in the previous level multiplied by the fan number of said previous level.

11. A method for mapping a source virtual disk (vDisk) to one or more units of target disk, comprising:
a) receiving in an digital electronic device an input data structure describing an input SV-balanced tree, wherein an SV-balanced tree contains:
(i) levels of nodes, each level having a single respective type and a single respective fan number, said type and fan number applicable to all nodes in that level,
(ii) a top level having a type of virtual disk (vDisk) and a fan number of 1 and containing a single source vDisk node,
(iii) a bottom level containing target disk nodes, each target disk node having a type of either vDisk or physical disk, and
(iv) at least one intermediate atomic function level having a type taken from a set of atomic function types including the mirror, concatenate, and stripe types;
b) inputting the input SV-balanced tree to transform logic executing in the device; and
c) transforming the input SV-balanced tree into an output SV-balanced tree by the transform logic.

12. The method of claim 11, wherein the step of transforming includes applying a rule from a level manipulation rule set in the transform logic to the input SV-balanced tree to obtain an output SV-balanced tree, said rule set including:
(i) a level combining rule, whereby two adjacent input levels level L and level L+1 in the input tree, said input levels having the same type taken from the set of atomic function types, are combined into a single output level L in the output tree, said output level L having a quantity of nodes equal to that of the input level L, and having a fan number equal to that of the input level L multiplied by the fan number of the input level L+1, and
(ii) a level swapping rule, whereby two adjacent input levels L and L+1 in the input tree, said input levels each having a respective type taken from the set of atomic function types, are swapped into two resulting output levels L and L+1 in the output tree, such that the type of output level L is equal to the type of input level L+1, the type of output level L+1 is equal to the type of input level L, the fan number of output level L is equal to that of input level L+1; the fan number of output level L+1 is equal to that of input level L; the quantity of nodes in output level L is equal to the quantity of nodes in input level L+1; and the quantity of nodes in output level L+1 is equal to the quantity of nodes in output level L multiplied by the fan number of output level L.

13. The method of claim 12, wherein the level manipulation rule set further includes:
(iii) a level splitting rule, whereby an input level L in the input tree, said input level having a type taken from the set of atomic function types, is split into two output levels L and L+1, each having the same type as having type as input level L, such that the product of the fan numbers of output levels L and L+1 is equal to the fan number of input level L.

14. The method of claim 12, wherein the level manipulation rule set further includes:
(iii) an identity level insertion rule, whereby a new level is inserted in the output tree between two adjacent levels of the input tree, said new level having a type taken from the set of atomic function types and a fan number equal to one.

15. The method of claim 12, wherein the level manipulation rule set further includes:
(iii) a vDisk level insertion rule, whereby a new level is inserted in the output tree between two adjacent levels of the input tree, said new level having a type of vDisk.

16. The method of claim 11, further comprising:
d) equilibrating in the digital electronic device the extents and node quantities of the levels in the output tree.

17. The method of claim 11, further comprising:
d) applying tracing logic to match each target disk of the input SV-balanced tree with a distinct target disk of the output SV-balanced tree such that each pair of matching target disks will correspond to the same data content from the source vDisk

18. The method of claim 17, wherein either the input SV-balanced tree contains no more than one level of stripe nodes having a fan number greater than one or is strongly matched.

19. The method of claim 17, wherein the input SV-balanced tree is weakly matched

20. A method for equilibrating an SV-balanced tree, comprising:
a) receiving a data structure for an SV-balanced tree, said data structure specifying:
(i) the number of levels in the tree;
(ii) for each level, a respective type applicable to all nodes in that level, the first level having a type of vDisk, the last level having a type of vDisk or pDisk, and each intermediate level having a type of vDisk, concatenate, mirror, or stripe;
(iii) for each level a respective fan number applicable to all nodes in that level, the fan number of the last level being 0, the fan number of each other level having a type of vDisk being 1, and the fan number of each level having a type of concatenate, mirror or stripe being a positive integer;
(iv) for a level L, an extent applicable to all nodes in level L; and
(v) for a level M, a quantity of nodes;
b) using logic executed in a digital electronic device, determining a quantity of nodes in a level L′ other than level L or an extent of a level M′ other than level M, said extent characterizing all nodes in level M′, by applying one of the following rules:
(i) the extent of a given level having type vDisk or mirror is equal to the extent of the subsequent level, if any;
(ii) the extent of a given level having type concatenate or stripe is equal to the extent of the subsequent level, if any, multiplied by the fan number of the given level; and
(iii) the quantity of nodes in a given level is equal to the quantity of nodes in the preceding level, if any, multiplied by the fan number of the preceding level.

21. An apparatus for mapping a source virtual disk (vDisk) to one or more units of target disk, comprising:
a) an input data structure describing an input SV-balanced tree, wherein an SV-balanced tree contains:
(i) levels of nodes, each level having a single respective type and a single respective fan number, said type and fan number applicable to all nodes in that level,
(ii) a top level having a type of virtual disk (vDisk) and a fan number of 1 and containing a single source vDisk node,
(iii) a bottom level containing target disk nodes, each target disk node having a type of either vDisk or physical disk, and
(iv) at least one intermediate atomic function level having a type taken from a set of atomic function types including the mirror, concatenate, and stripe types;
b) transform logic in a digital electronic device adapted to transforming the input SV-balanced tree into an output SV-balanced tree.

22. The apparatus of claim 21, wherein the transform logic is adapted to applying a rule from a level manipulation rule set to the input SV-balanced tree to obtain an output SV-balanced tree, said rule set including:
(i) a level combining rule, whereby two adjacent input levels level L and level L+1 in the input tree, said input levels having the same type taken from the set of atomic function types, are combined into a single output level L in the output tree, said output level L having a quantity of nodes equal to that of the input level L, and having a fan number equal to that of the input level L multiplied by the fan number of the input level L+1, and
(ii) a level swapping rule, whereby two adjacent input levels L and L+1 in the input tree, said input levels each having a respective type taken from the set of atomic function types, are swapped into two resulting output levels L and L+1 in the output tree, such that the type of output level L is equal to the type of input level L+1, the type of output level L+1 is equal to the type of input level L, the fan number of output level L is equal to that of input level L+1; the fan number of output level L+1 is equal to that of input level L; the quantity of nodes in output level L is equal to the quantity of nodes in input level L+1; and the quantity of nodes in output level L+1 is equal to the quantity of nodes in output level L multiplied by the fan number of output level L.

23. The apparatus of claim 22, wherein the level manipulation rule set further includes:
(iii) a level splitting rule, whereby an input level L in the input tree, said input level having a type taken from the set of atomic function types, is split into two output levels L and L+1, each having the same type as having type as input level L, such that the product of the fan numbers of output levels L and L+1 is equal to the fan number of input level L.

24. The apparatus of claim 22, wherein the level manipulation rule set further includes:
(iii) an identity level insertion rule, whereby a new level is inserted in the output tree between two adjacent levels of the input tree, said new level having a type taken from the set of atomic function types and a fan number equal to one.

25. The apparatus of claim 22, wherein the level manipulation rule set further includes:
(iii) a vDisk level insertion rule, whereby a new level is inserted in the output tree between two adjacent levels of the input tree, said new level having a type of vDisk.

26. The apparatus of claim 21, further comprising:
c) equilibration logic in the digital electronic device adapted to equilibrating the extents and node quantities of the levels in the output tree.

27. The apparatus of claim 21, further comprising:
c) tracing logic adapted to matching each target disk of the input SV-balanced tree with a distinct target disk of the output SV-balanced tree such that each pair of matching target disks will correspond to the same data content from the source vDisk

28. The apparatus of claim 27, wherein either the input SV-balanced tree contains no more than one level of stripe nodes having a fan number greater than one or is strongly matched.

29. The apparatus of claim 27, wherein the input SV-balanced tree is weakly matched

30. A structure for equilibrating an SV-balanced tree, comprising:
a) a data structure describing an SV-balanced tree, said data structure specifying:
(i) the number of levels in the tree;
(ii) for each level, a respective type applicable to all nodes in that level, the first level having a type of vDisk, the last level having a type of vDisk or pDisk, and each intermediate level having a type of vDisk, concatenate, mirror, or stripe;
(iii) for each level a respective fan number applicable to all nodes in that level, the fan number of the last level being 0, the fan number of each other level having a type of vDisk being 1, and the fan number of each level having a type of concatenate, mirror or stripe being a positive integer;
(iv) for a level L, an extent applicable to all nodes in level L; and
(v) for a level M, a quantity of nodes;
b) logic adapted to execution in a digital electronic device and further adapted to determining a quantity of nodes in a level L′ other than level L or an extent of a level M′ other than level M, said extent characterizing all nodes in level M′, by applying one of the following rules:
(i) the extent of a given level having type vDisk or mirror is equal to the extent of the subsequent level, if any;
(ii) the extent of a given level having type concatenate or stripe is equal to the extent of the subsequent level, if any, multiplied by the fan number of the given level; and
(iii) the quantity of nodes in a given level is equal to the quantity of nodes in the preceding level, if any, multiplied by the fan number of the preceding level.
